(19) United States
(12) Patent Application Publication
(10) Pub. No.: US 2007/0081189 A1
(43) Pub. Date: Apr. 12, 2007

(54) Image processing device, image processing system including image processing device, image processing method, and recording medium storing program product for controlling image processing device

(75) Inventors: Nobuo Kamei, Amagasaki-shi (JP); Fumiko Uchino, Otokuni-gun (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/340,704

(22) Filed: Jan. 27, 2006

(30) Foreign Application Priority Data
Oct. 6, 2005 (JP) 2005-293845

(51) Int. Cl. G06K 15/00

(52) U.S. Cl. 358/1.18; 358/1.9

(57) ABSTRACT

There is provided an image processing device which encourages a person who views an image to perform the following operations, thereby displaying information enabling execution of the operations. An image processing device 100 includes an input part 402 which accepts input of data, a detection part 404 which detects input for selecting an image, a generation part 406 which generates, for the selected image, an image file containing instruction of circulation in a group consisting of specific persons and other attribute information, and image data for thumbnail display, a storage part 416 which stores the data generated by the generation part 406, a sensing part 410 which senses a timing at which the image file is transmitted, a transmission control part 412 which executes an image file transmitting process, and a transmission part 414 which transmits the image file to a designated destination.

This application is based on Japanese Patent Application No. 2005-293845 filed with the Japan Patent Office on Oct. 6, 2005, the entire content of which is hereby incorporated by reference.

### BACKGROUND OF THE INVENTION

1. Field of the Invention

The present invention relates to a technique for accepting input of image data to display an image. More particularly, the present invention relates to an image processing device for generating and displaying image data and information about the image data, an image processing system including the image processing device, an image processing method, and a program product for controlling the image processing device.

2. Description of the Related Art

Examples of a device for displaying an image include monitors of a PC (Personal Computer) and other computer systems. Data for displaying an image is transmitted as an image file from a generation source thereof to a designated transmission destination (e.g., a device for displaying the image). As for display of an image, in order to improve convenience of the device to a user, there has been known a technique for displaying a list of details of an image received by the device as a so-called thumbnail image.

Moreover, for example, Japanese Laid-Open Patent Publication No. 2002-271553 discloses an image communication device capable of transmitting an image and additional information. Japanese Laid-Open Patent Publication No. 2003-051975 discloses a technique for confirming an image provided with tag information.

In addition, as for data transfer, there is a technique for substituting an encrypted mark without displaying an encrypted image as a thumbnail image (see, e.g., Japanese Laid-Open Patent Publication No. 11-143907).

In these techniques, however, it is impossible to send information, which is desirable to let a person who views an image know, to the person. Therefore, there arises a problem that it is impossible to provide, to the person who views an image, operating instructions such as an instruction for encouraging the next execution using the information.

The present invention has been made to solve the aforementioned problems, and a first object thereof is to provide an image processing device capable of protecting data of an image file and, also, generating a file which enables confirmation of the attribute or use of a file or operating instructions with respect to a person who views the file.

A second object of the present invention is to provide an image processing device capable of generating a file which enables confirmation of the attribute or use of each of a plurality of files and operating instructions.

A third object of the present invention is to provide an image processing system capable of protecting data of an image file and, also, generating a file which enables confirmation of the attribute or use of the file or operating instructions with respect to a person who views the file.

A fourth object of the present invention is to provide an image processing method capable of protecting data of an image file and, also, generating a file which enables confirmation of the attribute or use of the file or operating instructions with respect to a person who views the file.

A fifth object of the present invention is to provide a recording medium which stores a program product for controlling an image processing device as an image processing device capable of protecting data of an image file and, also, generating a file which enables confirmation of the attribute or use of the file or operating instructions with respect to a person who views the file.

### SUMMARY OF THE INVENTION

In summary, in order to achieve the aforementioned objects, an image processing device according to an aspect of the present invention includes an input part to accept input of image data and attribute information containing instruction information for instructing an operation for the image data, an image file generation part to generate an image file capable of displaying an image based on the image data or the attribute information on the basis of the image data and the attribute information that the input thereof is accepted by the input part, a storage part to store the image file generated by the image file generation part, and a display part to display the image or the attribute information on the basis of the image file stored in the storage part.

Preferably, the image file contains first image data that input thereof is accepted by the input part, and the attribute information that the input thereof is accepted by the input part.

Preferably, the image file further contains second image data for displaying the attribute information that the input thereof is accepted by the input part.

Preferably, the image file generation part performs an encrypting process to the first image data and does not perform the encrypting process to the second image data.

Preferably, the image processing device further includes a creation part to create the second image data on the basis of the attribute information that the input thereof is accepted by the input part. The image file generation part generates the image file containing the second image data created by the creation part.

Preferably, the image processing device further includes a second image data storage part to store the second image data prepared in advance, a second image data display part to display the second image data stored in the second image data storage part, and a selection part to select the second image data displayed on the second image data display part. The image file generation part generates an image file containing the second image data selected by the selection part.

Preferably, the image file generation part includes a binding part to bind a plurality of pieces of image data that input thereof is accepted by the input part to each other, and a generation part to generate a plurality of the second image data for the purpose of displaying the attribute information for each of the plurality of pieces of image data.

Preferably, the input part further accepts input of control data for controlling whether or not the image can be displayed. The image file generation part generates the image file on the basis of the control data.

Preferably, in the case of receiving permission data for permitting display of the image, the image file generation part generates a file for permitting display of the image, as the image file, in accordance with the input of the permission data.

Preferably, in the case of receiving prohibition data for prohibiting display of the image, the image file generation part generates a file for prohibiting display of the image, as the image file, in accordance with the input of the prohibition data.

Preferably, the image file generation part generates the image file without addition of data for prohibiting display of the attribute information.

An image processing system according to another aspect of the present invention has an image display device which displays an image on the basis of data inputted via a network, and an image processing device which is connected to the image display device through the network. The image processing device includes an input part to accept input of image data for displaying an image and attribute information of the image, a storage part to store specification information for specifying a position of the image display device in the network, a generation part to generate an image file capable of displaying the image and the attribute information on the basis of the image data and the attribute information, and a transmission part to transmit the image file generated by the generation part to the image display device on the basis of the specification information.

An image processing method according to still another aspect of the present invention includes the steps of accepting input of image data and attribute information containing instruction information for instructing an operation for the image data, generating an image file capable of displaying the image or the attribute information, on the basis of the image data and the attribute information that the input thereof is accepted, storing the generated image file, and displaying the image or the attribute information on the basis of the stored image file.

Preferably, the image file contains first image data that the input thereof is accepted, and the attribute information that the input thereof is accepted.

Preferably, the image file further contains second image data for displaying the attribute information that the input thereof is accepted.

Preferably, the generating step includes the steps of performing an encrypting process to the first image data, and performing no encrypting process to the second image data.

Preferably, the image processing method further includes the step of creating the second image data on the basis of the attribute information that the input thereof is accepted. The generating step generates the image file containing the created second image data.

Preferably, the image processing method further includes the steps of storing the second image data prepared in advance, displaying the second image data, and selecting the displayed second image data. The generating step generates an image file containing the selected second image data.

Preferably, the generating step includes the steps of binding a plurality of pieces of image data that input thereof is accepted to each other, and generating a plurality of the second image data for the purpose of displaying the attribute information for each of the plurality of pieces of image data.

Preferably, the image processing method further includes the step of accepting input of control data for controlling whether or not the image can be displayed. The generating step generates the image file on the basis of the control data.

According to yet another aspect of the present invention, there is provided a recording medium in which a program for controlling an image processing device is stored. The program allows the image processing device to execute the steps of accepting input of image data and attribute information containing instruction information for instructing an operation for the image data, generating an image file capable of displaying the image or the attribute information, on the basis of the image data and the attribute information that the input thereof is accepted, storing the generated image file, and displaying the image or the attribute information on the basis of the stored image file.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a mode that an image processing device according to the present invention transmits a file having a thumbnail image attached thereto.

FIG. 2 shows a mode that a file 202 in which attribute information is added to a page for thumbnail display is transmitted from an image processing device 100 to an image display device 150 or 160.

FIG. 3 is a block diagram which shows a hardware configuration of image processing device 100.

FIG. 4 is a block diagram which shows a functional configuration of image processing device 100.

FIG. 5 is a flowchart which shows a procedure of processes executed by a CPU 110 of image processing device 100 according to a first embodiment of the present invention.

FIG. 6 is a flowchart which shows a procedure of processes executed by a CPU of a computer system functioning as an image display device according to the first embodiment of the present invention.

FIGS. 7 to 11 show one mode of data storage in a user data memory 111.

FIG. 12 is a flowchart which shows a procedure of processes executed by CPU 110 for the purpose of creating a transmission destination/attribute information list.

FIG. 13 is a flowchart which shows a procedure of processes executed by CPU 110 for the purpose of reading an image in a scanner part 118.

FIGS. 14 to 19 are flowcharts each of which shows a procedure of processes executed by CPU 110 for the purpose of creating a file.

FIG. 20 shows a format of a file generated in a work RAM 115.

FIG. 21 shows a structure of data stored in work RAM 115 temporarily for the purpose of selecting a page for thumbnail display.

FIG. 22 is a block diagram which shows a hardware configuration of a computer system 2200 for realizing image processing device 100.

FIG. 23 is a block diagram which shows a functional configuration of image display device 150.

FIG. 24 shows one mode of data storage in a hard disk drive 2250 of computer system 2200 functioning as image display device 150.

FIG. 25 shows display of a thumbnail image on a monitor 2280 of computer system 2200 functioning as image display device 150.

FIG. 26 shows a screen displayed by an image display device on the basis of an image file generated according to a conventional mode.

FIGS. 27 and 28 are flowcharts each of which shows a procedure of processes executed by CPU 110 of an image processing device according to a second embodiment of the present invention.

FIG. 29 is a flowchart which shows a procedure of processes executed by a CPU 2210 of an image display device according to the second embodiment of the present invention.

FIGS. 30 to 34 are flowcharts each of which shows a procedure of processes executed by CPU 110 of an image processing device according to a third embodiment of the present invention.

FIGS. 35 and 36 are flowcharts each of which shows a procedure of processes executed by CPU 2210 of an image display device according to the third embodiment of the present invention.

FIG. 37 shows one mode of a bind list in work RAM 115 of the image processing device according to the third embodiment of the present invention.

FIG. 38 shows a mode that a file is generated on the basis of the bind list.

FIG. 39 shows a format of a file generated by the image processing device according to the third embodiment of the present invention.

FIG. 40 shows a file display screen on monitor 2280 of the image display device according to the third embodiment of the present invention.

FIG. 41 is a block diagram which shows a functional configuration realized by an image processing device 4100 according to a fourth embodiment of the present invention.

FIGS. 42 and 43 are flowcharts each of which shows a procedure of processes executed by CPU 110 of image processing device 4100.

### DESCRIPTION OF THE PREFERRED EMBODIMENTS

Hereinafter, description will be given of embodiments of the present invention with reference to the drawings. In the following description, the same reference marks refer to the same components. Names and functions thereof are also the same. Therefore, detailed description thereof will not be repeated.

### First Embodiment

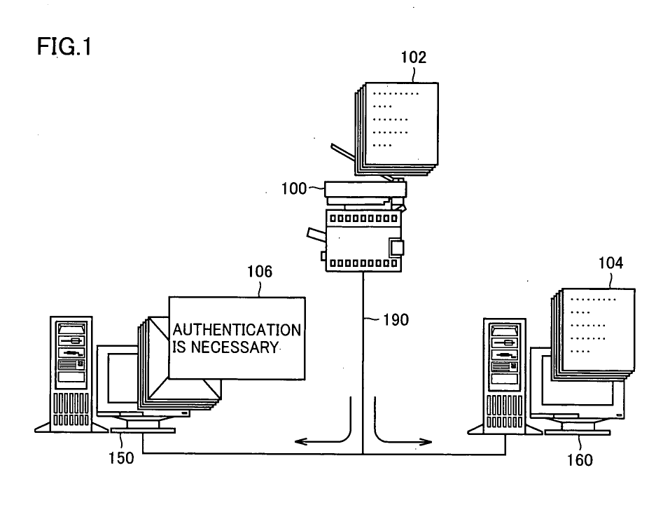

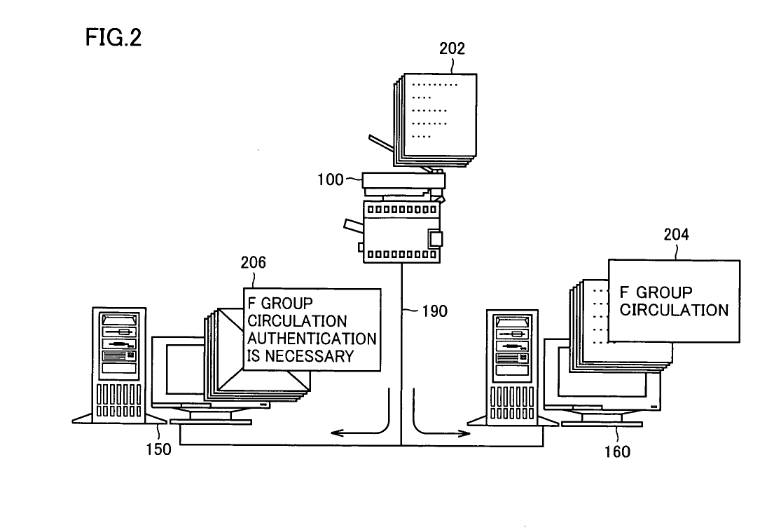

With reference to FIGS. 1 and 2, description will be given of a use mode of an image processing device according to the present invention. FIG. 1 shows a transmission mode of a file to which a thumbnail image is attached as necessary.

An image processing device 100 is connected to image display devices 150 and 160, respectively via a cable 190. Image processing device 100 is realized as, for example, a copy machine, an MFP (Multi Function Peripheral), a facsimile transmission/reception machine, or other image formation device. In this case, image processing device 100 transmits, as image data, data generated by scanning to image display device 150 or 160.

In the case where image display device 150 has a function of controlling access of a file in accordance with a preset authentication level, image processing device 100 adds information representing that authentication is necessary to a file 102 generated by data scanning and, then, transmits file 102. Image display device 150 receives the file transmitted from image processing device 100 as, for example, a file 106. File 106 is subjected to a protecting process which controls viewing of a text thereof on the basis of information preset with respect to the text. Accordingly, if a user of image display device 150 accesses file 106, the user must input a password preset in advance between image processing device 100 and image display device 150.

On the other hand, in the case where image processing device 100 transmits file 102 to a device which requires no user authentication (e.g., image display device 160), image processing device 100 generates data representing a thumbnail image of an initial page in file 102, adds the data to file 102, and transmits file 102 to image display device 160. Image display device 160 receives such a file as a file 104. File 104 is not subjected to the protecting process as file 106 is. Therefore, any users capable of using image display device 160 can refer to contents of file 104.

FIG. 2 shows a mode that a file 202 in which attribute information is added to a page for thumbnail display is transmitted from image processing device 100 to image display device 150 or 160.

For example, information for instructing circulation in a group consisting of specific users may be added as attribute information to data acquired by a scanning process. In this case, a person who views a file having such attribute information added thereto views the file in a group specified by the attribute information. That is, image processing device 100 generates data for transmission through a scanning process of a document to be transmitted. Image processing device 100 adds data, which is prepared in advance for the purpose of instructing circulation in a group of specific users, as attribute information to the data generated by the scanning process. The data generated as described above is transmitted as file 202 to image display device 150 or 160 via cable 190. In the case where access to the received file is restricted in advance in image display device 150 as described above, information which notifies that an authenticating process is necessary is further added to the data transmitted to image display device 150, in addition to the data generated by image processing device 100. That is, image display device 150 receives the file transmitted from image processing device 100, as a file 206. File 206 contains attribute information for instructing circulation in a group consisting of specific users (e.g., “F group circulation”), and attribute information for notifying that a preset password must be inputted for the purpose of accessing the file (e.g., “authentication is necessary”). Upon reception of file 206, image display device 150 displays information attached to an initial portion of the file on a display part (not shown) thereof. When a user who belongs to a group specified by file 206 inputs a password preset between image processing device 100 and image display device 150, image display device 150 sequentially displays a text attached to file 206.

On the other hand, in the case where access to the file transmitted between image processing device 100 and image display device 160 is not particularly restricted, image processing device 100 transmits file 202 to image display device 160 without giving the aforementioned data for restricting access. Image display device 160 holds the received file as, for example, a file 204, and sequentially displays file 204 on a display part (not shown) thereof Herein, file 204 contains attribute information for instructing circulation in a group of specific users (e.g., “F group circulation”); therefore, the display part displays the information.

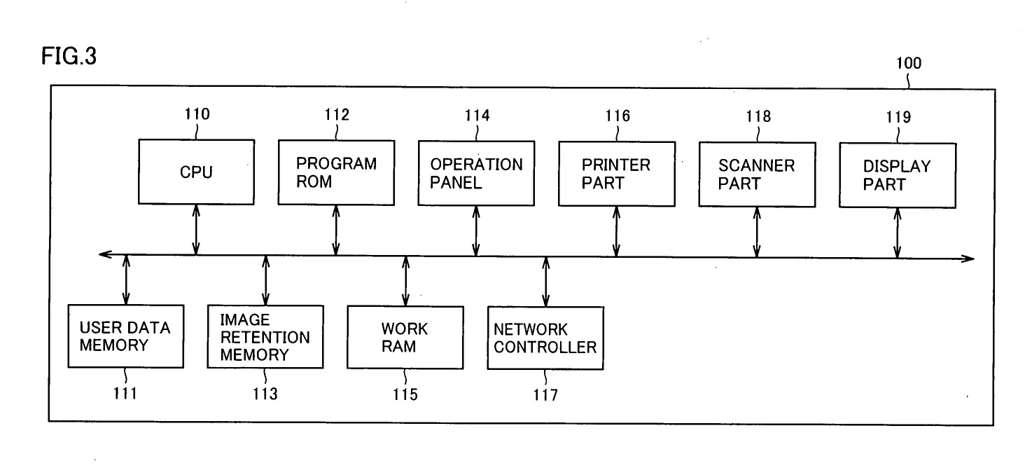

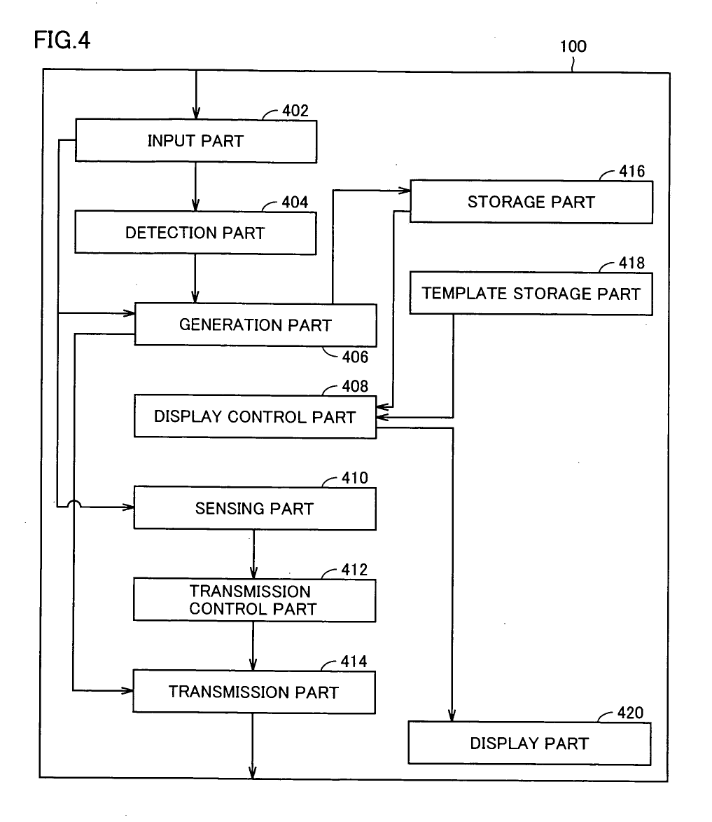

With reference to FIGS. 3 and 4, description will be given of image processing device 100 according to this embodiment. FIG. 3 is a block diagram which shows a hardware configuration of image processing device 100.

Image processing device 100 includes a CPU (Central Processing Unit) 110, a user data memory 111, a program ROM (Read Only Memory) 112, an image retention memory 113, an operation panel 114, a work RAM (Random Access Memory) 1I15, a printer part 116, a network controller 117, a scanner part 118 and a display part 119, which are mutually connected to each other via a data bus.

CPU 110 executes processes for realizing image processing device 100 on the basis of data or executable programs stored in user data memory 111, image retention memory 113, work RAM 115 and program ROM 112. User data memory 111 stores data preset between image display devices 150 and 160 connected with image processing device 100 (e.g., a password for accessing a file, etc.). Program ROM 112 stores a program product created for the purpose that image processing device 100 executes a predetermined process. This program product includes, for example, a program for executing a scanner process on the basis of the designated resolution, a program for generating information for restricting access to a specific file on the basis of a password stored in user data memory 111, a program for defining an operation by printer part 116, a program for transmitting a file to a designated destination through network controller 117, a program for allowing display part 119 to display a status of the process in scanner part 118, and information representing the operation of image processing device 100, and the like.

Image retention memory 113 stores image data generated by the scanner process by scanner part 118. Image retention memory 113 may retain image data created in advance.

Operation panel 114 accepts input of an operation for defining the operation of image processing device 100 from the outside. Operation panel 114 is realized by, for example, a numeric keypad, button, or touch panel-type form. Work RAM 115 stores data, which is temporarily generated by execution of the process of CPU 110 in a volatile manner. This data contains, for example, a file generated for transmission on the basis of the data generated by scanner part 118. Printer part 116 forms an image on the basis of the data stored in work RAM 115, and forms and outputs the image onto a sheet. Network controller 117 transmits, to a designated address, the file stored in work RAM 115 on the basis of the instruction from CPU 110. Scanner part 118 scans the image from the sheet placed at a predetermined position of an image pickup element (not shown) on the basis of the instruction outputted by CPU 110. The scanned data is temporarily retained in work RAM 115 and, then, is stored in, for example, image retention memory 113 by input for firm determination through operation panel 114. Display part 119 displays information representing the operation of image processing device 100, or setting information inputted through operation panel 114.

FIG. 4 is a block diagram which shows a functional configuration of image processing device 100. Image processing device 100 includes an input part 402 which accepts input of data from the outside, an detection part 404 which detects input for selecting a displayed image from the data inputted through input part 402, a generation part 406 which generates an image file containing attribute information of the image selected on the basis of the data inputted through input part 402 and the input for selection detected by detection part 404, and a storage part 416 which stores the data generated by generation part 406. Generation part 406 also generates image data for thumbnail display. Image processing device 100 further includes a template storage part 418 which stores template data for displaying an image corresponding to attribute information prepared in advance, a display control part 408 which generates data for display on the basis of the data stored in storage part 416 and the data stored in template storage part 418, and a display part 420 which displays an image on the basis of the data.

Image processing device 100 further includes a sensing part 410 which senses a timing at which an image file is transmitted on the basis of the input through input part 402, a transmission control part 412 which executes an image file transmitting process on the basis of the timing sensed by sensing part 410, and a transmission part 414 which transmits an image file to a designated destination on the basis of the data from transmission control part 412 or the data generated by generation part 406.

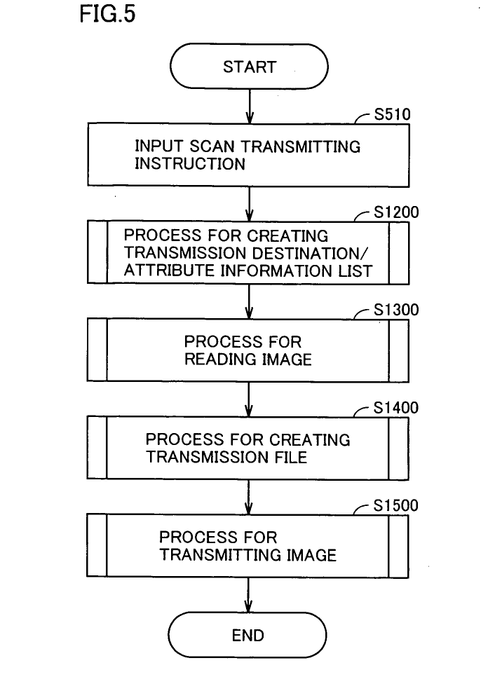

With reference to FIG. 5, description will be given of a control structure of image processing device 100 according to this embodiment. FIG. 5 is a flowchart which shows a procedure of processes executed by CPU 110 for the purpose of transmitting an image file.

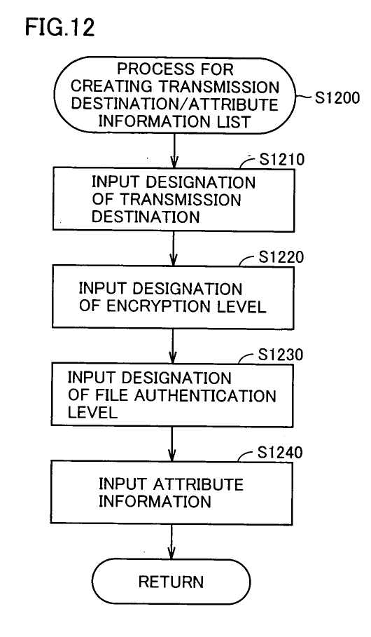

In step S510, CPU 110 of image processing device 100 senses input of a scan transmitting instruction on the basis of input through operation panel 114. In step S1200, CPU 110 executes a process for preparing a distribution destination/attribute information list which will be described later (FIG. 12). Upon execution of this process, input of information such as a transmission destination, attribute information and the like of a file is accepted and the accepted information is held as data for transmission.

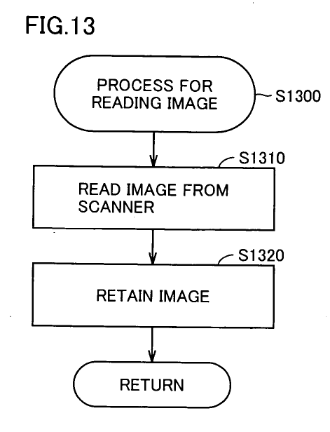

In step S1300, CPU 110 executes a process for reading an image which will be described later (FIG. 13). This process is realized in such a manner that CPU 110 transmits a predetermined control signal to scanner part 118. Upon execution of this process, a manuscript mounted on a scanner (not shown) is read.

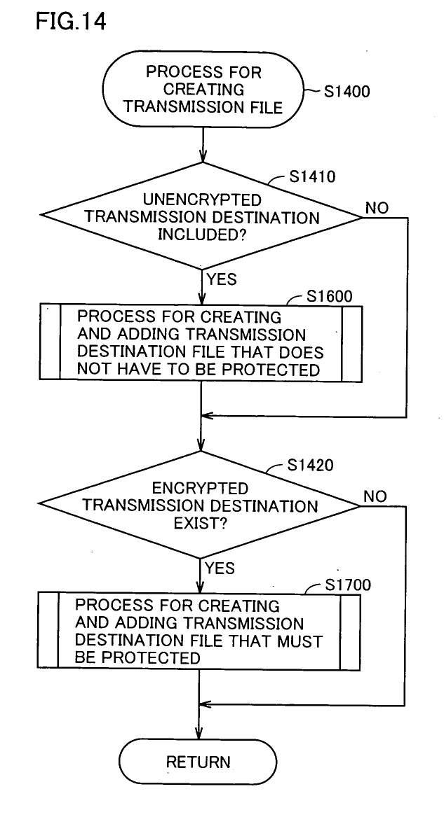

In step S1400, CPU 110 executes a process for creating a transmission file which will be described later (FIG. 14). Upon execution of this process, a transmission file (e.g., file 102, 202) is generated on the basis of the read image file stored in work RAM 115 and the data stored in user data memory 111.

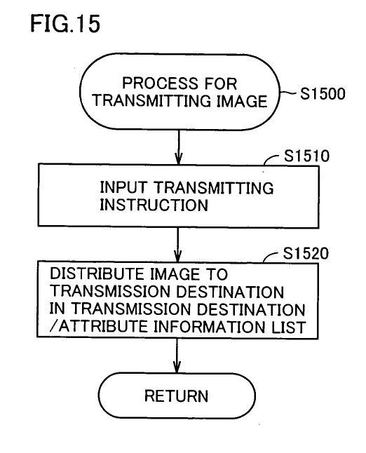

In step S1500, CPU 110 executes a process for transmitting an image which will be described later (FIG. 15). Upon execution of this process, an image of the generated file is distributed to a transmission destination included in the transmission destination/attribute information list through network controller 117.

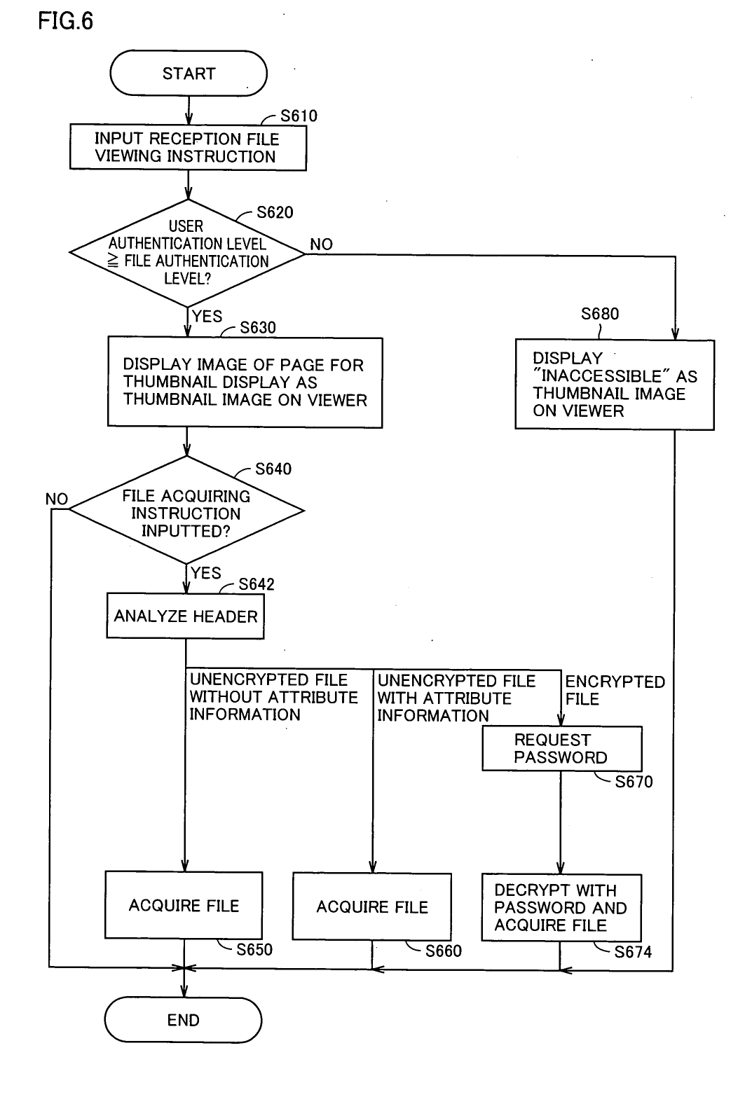

With reference to FIG. 6, description will be given of a control structure of image display devices 150 and 160 according to this embodiment. Herein, each of image display devices 150 and 160 is realized by, for example, a computer system having a data retaining function and an arithmetic processing function. The computer system has a central processing unit referred to as a so-called CPU, for the purpose of realizing the functions. In the following description, therefore, it is assumed that image display devices 150 and 160 are realized by processes in the CPU of the computer system.

In step S610, the CPU senses input of a reception file viewing instruction on the basis of input through a keyboard, a mouse or other input device (not shown) of the system. In step S620, the CPU determines whether or not a user authentication level given to the file is equal to or more than an authentication level of the file. If the user authentication level is equal to or more than the file authentication level (YES in step S620), the process proceeds to step S630. If not (NO in step S620), the process proceeds to step S680.

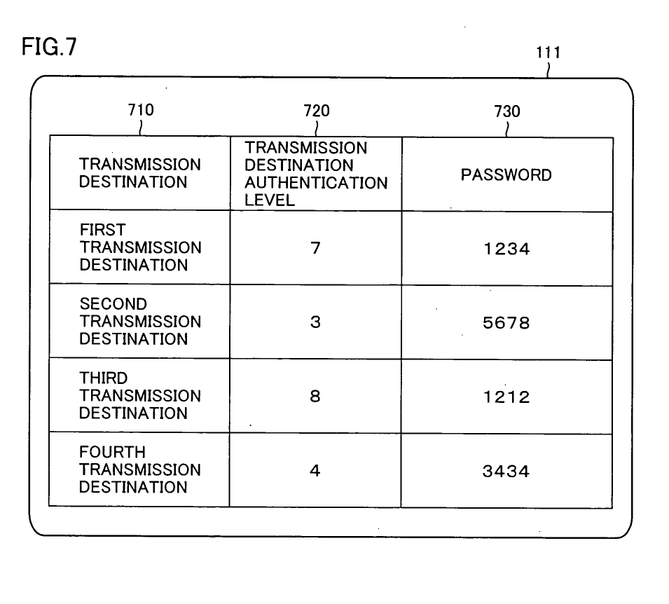

Herein, the user authentication level is a value which was already obtained at log-in performed by a user when the user uses image display device 150. In image display device 160 which requires no user authentication, the user authentication level is controlled using a transmission destination authentication level shown in FIG. 7, which will be described later.

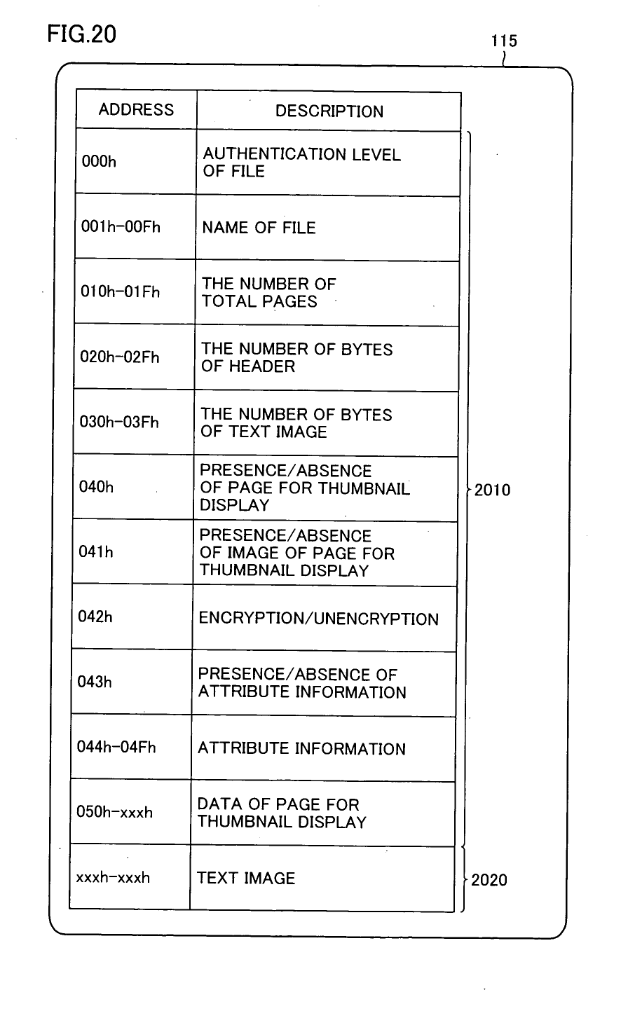

In step S630, the CPU transmits a predetermined control signal to a viewer (not shown), thereby displaying a thumbnail image of a page for thumbnail display contained in a header of a file (which will be described later with reference to FIG. 20). In step S640, the CPU determines whether or not a file acquiring instruction is inputted on the basis of the input through the mouse. If the instruction is inputted (YES in step S640), the process proceeds to step S642. If not (NO in step S640), the process is finished.

In step S642, the CPU executes a predetermined process for analyzing a header with respect to the received file. When this analyzing process is executed, details, for example, whether or not the file is encrypted, whether or not the file has attribute information, and the like are confirmed. In accordance with the results of this confirmation, the following process is carried out.

More specifically, if the received file is not encrypted and has no attribute information, the process proceeds to step S650. If the received file is not encrypted and has attribute information, the process proceeds to step S660. If the received file is encrypted, the process proceeds to step S670.

In step S650, the CPU acquires data of the file, and stores the data in an area reserved in a memory (not shown). In step S660, the CPU acquires the file, and stores information of the file in an area temporarily reserved in the memory.

In step S670, the CPU outputs a predetermined control signal for the purpose of executing an authenticating process, thereby requesting a password. On the basis of this request, a display (not shown) of the computer system displays a fact that a password is necessary to view the received file on its display area.

In step S674, the CPU decrypts the received file on the basis of the password inputted in accordance with the request in step S670, acquires the original file, and stores the acquired file in the area of the memory.

With reference to FIGS. 7 to 11, description will be given of a data structure of image processing device 100 according to this embodiment. FIGS. 7 to 11 respectively show a data storage mode in user data memory 111.

FIG. 7 shows an authentication information list. The authentication information list is stored in user data memory 111. The authentication information list includes an area 710 for storing transmission destinations, an area 720 for storing authentication levels preset to the respective transmission destinations, and an area 730 for storing passwords inputted to the respective transmission destinations in advance.

The transmission destination includes, for example, an identification name for each of image display devices 150 and 160 shown in FIG. 1 or an address in the network, In addition to such physically specified information, the transmission destination may include, for example, a unique name inputted by a user of the image display device.

The authentication level is a specific level selected from among levels prepared in advance for the purpose of controlling access to a file transmitted from image processing device 100. In the case where the authentication level is constructed from, for example, 10 stages, any one level corresponding to one of levels “1” to “10” is stored in area 720. With this authentication level, in the case of reception of a file provided with a level which is lower than the level, a user of the image display device can access the file. On the other hand, the relation between the authentication level and the level attached to the file is inverse, access to the file is restricted.

The password is data registered in advance for the purpose of accessing a received file. Corresponding passwords are set to the respective transmission destinations. In accordance with presence/absence of the password, it is determined whether or not a file can be accessed in a transmission destination.

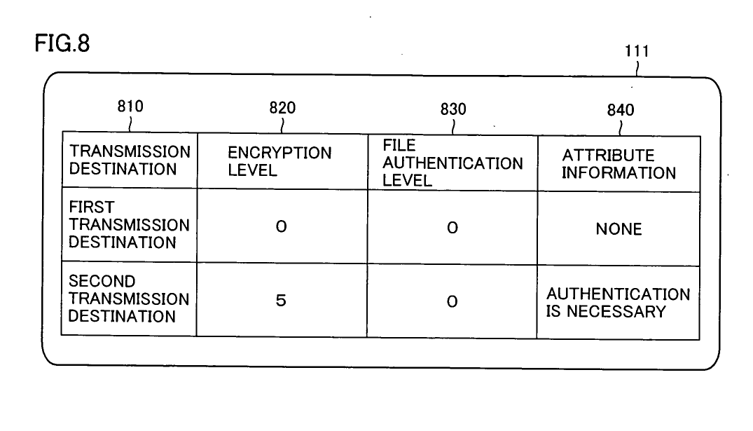

FIG. 8 shows a transmission destination/attribute information list. With reference to FIG. 8, user data memory 111 includes areas 810 to 840 each of which stores data.

Data representing a transmission destination (e.g., the name of a transmitter or the name of a transmission group) is stored in area 810. An encryption level set to the transmission destination is stored in area 820. A file authentication level set to the transmission destination is stored in area 830. Data representing attribute information for the transmission destination is stored in area 840.

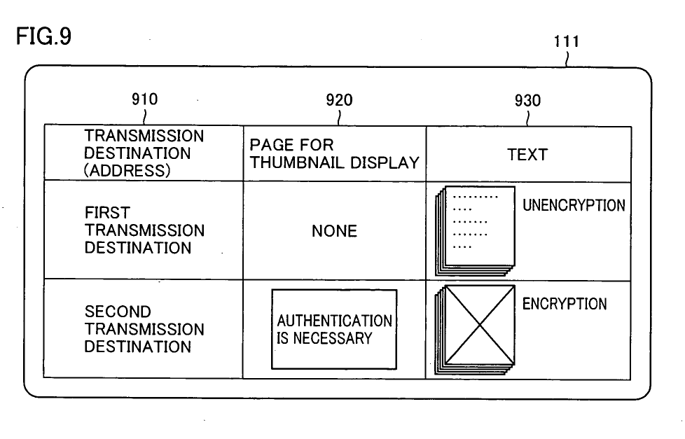

FIG. 9 shows a storage mode of a file generated for transmission. This file is stored in, for example, user data memory 111, but may be other memory such as work RAM 115. User data memory 111 includes areas 910 to 930 each of which stores data.

Data representing a transmission destination (e.g., an address) is stored in area 910. In the case where there exists attribute information for a file to be transmitted, generation part 406 creates data representing the attribute information as a page for thumbnail display for displaying the attribute information. This data is stored in area 920 as image data for thumbnail display. The file generated for transmission is stored in area 930. This file is encrypted in some cases or, alternatively, is not encrypted in some cases.

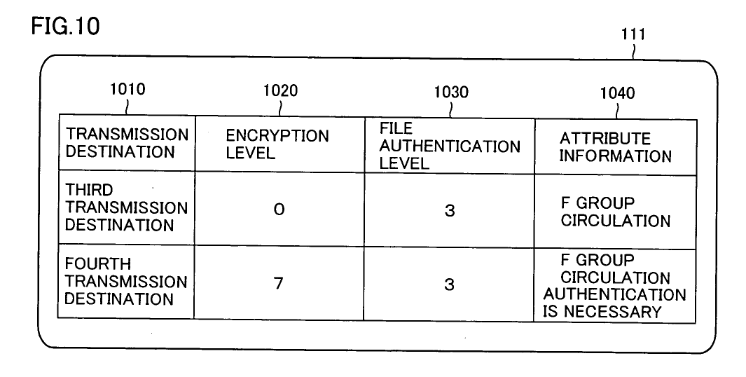

FIG. 10 shows a transmission destination/attribute information list according to another aspect. User data memory 111 includes areas 1010 to 1040 each of which stores data.

Data representing a transmission destination is stored in area 1010. An encryption level is stored in area 1020. A file authentication level is stored in area 1030. Attribute information is stored in area 1040. For example, information for instructing only users constituting a specific group of circulation is stored as “F group circulation” representing the attribute information.

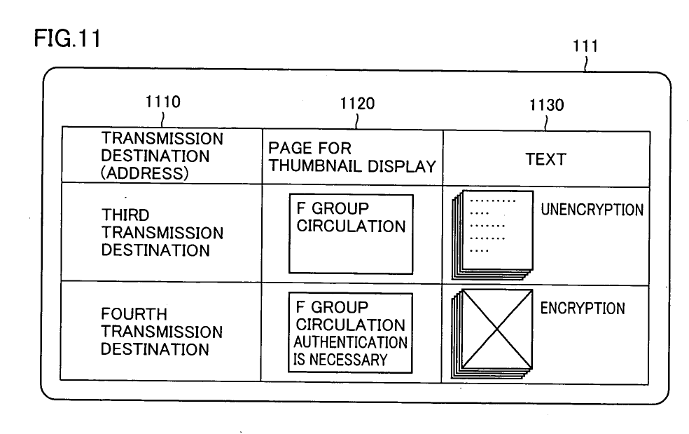

FIG. 11 shows a storage mode of a file generated for transmission. Use data memory 111 includes areas 1110 to 1130 each of which stores data.

Data for specifying a data transmission destination (e.g., an address) is stored in area 1110. A page for thumbnail display, which is generated for displaying attribute information, is stored in area 1120. A text file generated for transmission is stored in area 1130. For example, data for displaying “F group circulation” is created as a page for thumbnail display with respect to a third transmission destination. With respect to this transmission destination, a file as a text is not encrypted. On the other hand, a thumbnail displaying “authentication is necessary” indicating that input of a password is requested for the purpose of controlling access is generated as attribute information with respect to a fourth transmission destination, in addition to “F group circulation”. The file transmitted to this transmission destination is encrypted.

With reference to FIGS. 12 to 19, description will be further given of the control structure of image processing device 100 according to this embodiment. FIG. 12 is a flowchart which shows a procedure of processes executed by CPU 110 for the purpose of creating the transmission destination/attribute information list shown in FIGS. 8 and 10.

In step S1210, CPU 110 senses input for designating a transmission destination through operation panel 114. In step S1220, CPU 110 accepts input for designating an encryption level on the basis of the input to operation panel 114. In step S1230, CPU 110 accepts input for designating a file authentication level on the basis of the input through operation panel 114. In step S1240, CPU 110 accepts input of attribute information through operation panel 114. Thereafter, the process returns to a process in which the process is called.

Herein, there is shown a case where CPU 110 accepts data for creating the list on the basis of the input through operation panel 114. However, the data is similarly realized by reading out, for example, input through network controller 117 or data stored in a removable data recording medium (not shown).

FIG. 13 is flowchart which shows a procedure of processes executed by CPU 110 for the purpose of reading an image in scanner part 118.

In step S1310, CPU 110 outputs, to scanner part 118, an instruction for executing a process for reading an image. This instruction is outputted in response to input through operation panel 114, for example. Scanner part 118 drives an image pickup element (not shown) on the basis of this instruction, executes an image pickup process and, then, acquires an electric signal from an optical signal. The acquired signal is stored as image data in an area temporarily reserved in work RAM 115.

In step S1320, CPU 110 outputs an instruction for retaining the image data stored in work RAM 115, on the basis of input through operation panel 114. With this instruction, the image data is transferred to image retention memory 118 and is retained therein in a volatile manner.

FIG. 14 is a flowchart which shows a procedure of processes executed by CPU 110 for the purpose of creating a file transmitted to the image display device.

In step S1410, CPU 110 determines whether or not a transmission destination of an unencrypted file is included in transmission targets. If such a transmission destination is included (YES in step S1410), the process proceeds to step S1600. If not (NO in step S1410), the process proceeds to step S1420.

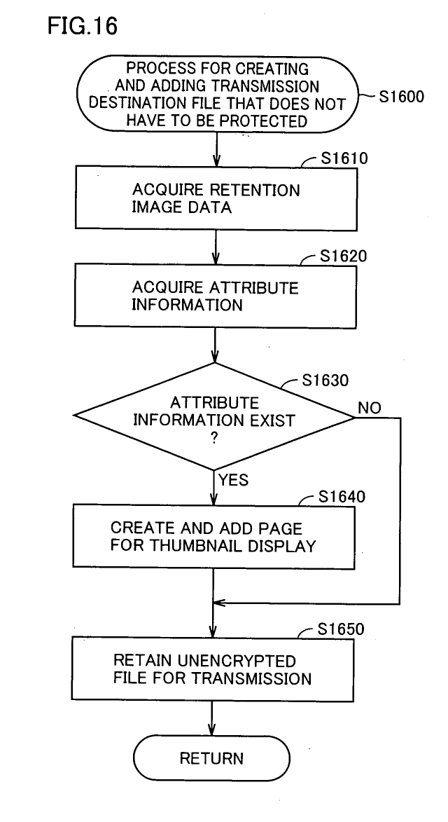

In step S1600, CPU 110 executes a process for creating and adding a transmission destination file that does not have to be protected, which will be described later (FIG. 16). Upon execution of this process, a file which is not encrypted as a file for transmission is generated (i.e., a file which has no access restriction is generated).

In step S1420, CPU 110 determines whether or not there exists a transmission destination which requires transmission of an encrypted file. If such a transmission destination exists (YES in step S1420), the process proceeds to step S1700. If not (NO in step S1420), the process returns to the main process.

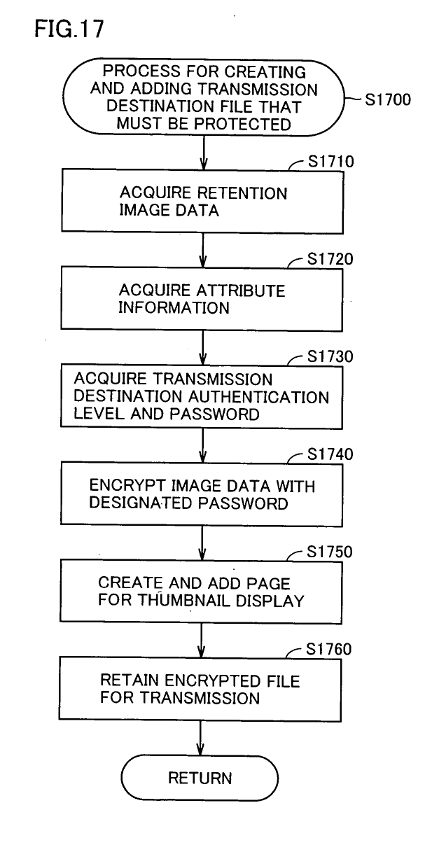

In step S1700, CPU 110 executes a process for creating and adding a transmission destination file that must be protected, which will be described later (FIG. 17). Upon execution of this process, a file which is encrypted by a password designated in advance is generated.

FIG. 15 is a flowchart which shows a procedure of processes executed by CPU 110 for the purpose of transmitting an image.

In step S1510, CPU 110 accepts input of an transmitting instruction through operation panel 114. In step 1520, CPU 110 distributes an image file stored in image retention memory 113 to a transmission destination included in the transmission destination/attribute information list.

FIG. 16 is a flowchart which shows a procedure of processes executed by CPU 110 for the purpose of creating a transmission destination file that does not have to be protected.

In step S1610, CPU 110 acquires image data stored in image retention memory 113. In step S1620, CPU 110 acquires attribute information stored in user data memory 111. In step S1630, CPU 110 determines whether or not attribute information to be transmitted to a designated transmission destination exists. If the attribute information exists (YES in step S1630), the process proceeds to step S1640. If not (NO in step S1630), the process proceeds to step S1650.

In step S1640, CPU 110 creates a page for thumbnail display and adds the created page to image data, thereby generating a file for transmission. In step S1650, CPU 110 stores the generated file, that is, an unencrypted file for transmission in an area temporarily reserved in work RAM 115. Herein, in the case where the file is not immediately transmitted but will be transmitted later, the generated file may be stored in image retention memory 113 or another nonvolatile memory. Thus, a user can transmit the generated file at an optional timing.

FIG. 17 is a flowchart which shows a procedure of processes executed by CPU 110 for the purpose of creating a file that must be protected.

In step S1710, CPU 110 acquires data stored in image retention memory 113. In step S1720, CPU 110 acquires attribute information from the transmission destination/attribute information list (FIGS. 8 and 10) stored in user data memory 111. In step S1730, CPU 110 also reads out a password inputted in advance, from the authentication information list (FIG. 7).

In step S1740, CPU 110 uses the password to encrypt image data in accordance with the encryption level in the transmission destination/attribute information list. In step S1750, CPU 110 creates a page for thumbnail display on the basis of image data prepared in advance and a criterion for a compressing process and, then, adds the page to the image data, thereby generating a file for transmission.

In step S1760, CPU 110 writes the generated file (i.e., an encrypted file for transmission) into work RAM 115. Alternatively, in the case where the file is transmitted later, CPU 110 may retain the generated file in image retention memory 113 or other nonvolatile memory, in order to avoid destruction of the file.

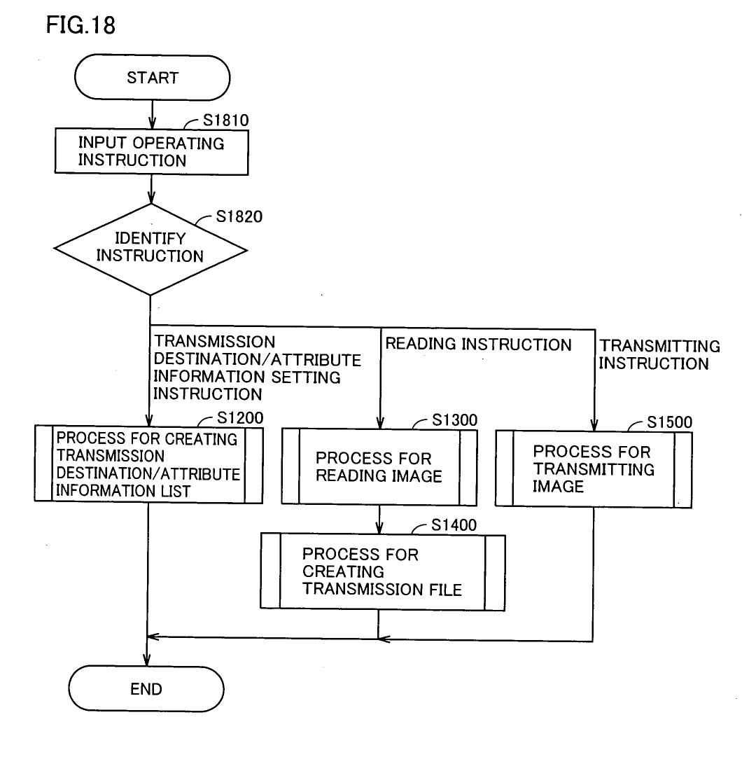

FIG. 18 is a flowchart which shows a procedure of processes executed by CPU 110 for the purpose of generating a file at the time of reading an image through scanner part 118. It is to be noted that the same processes as the aforementioned processes are denoted by the same step numbers; therefore, description thereof will not be repeated herein.

In step S1810, CPU 110 accepts input of an instruction for creating a file on the basis of input through operation panel 114. In step S1820, CPU 110 identifies the instruction and an instruction inputted on the basis of data for instruction identification. The data is stored in, for example, program ROM 112 in advance. The instruction to be inputted includes an instruction for setting a transmission destination or attribute information, an instruction for reading an image, an instruction for transmitting a file, and the like.

If the inputted instruction is an instruction for setting a transmission destination or attribute information, the process proceeds to step S1200. If the inputted instruction is an instruction for reading an image, the process proceeds to step S1300. In step S1300, an image is read and, then, the process proceeds to a process for creating a transmission file in step S1400. However, it is not always necessary to perform the transmission. The created file may be stored in the storage part of the image processing device. In this case, the process is carried out using each storage area (e.g., a box) in the same image processing device as a transmission destination. If the inputted instruction is the one for transmitting a file, the process proceeds to step S1500.

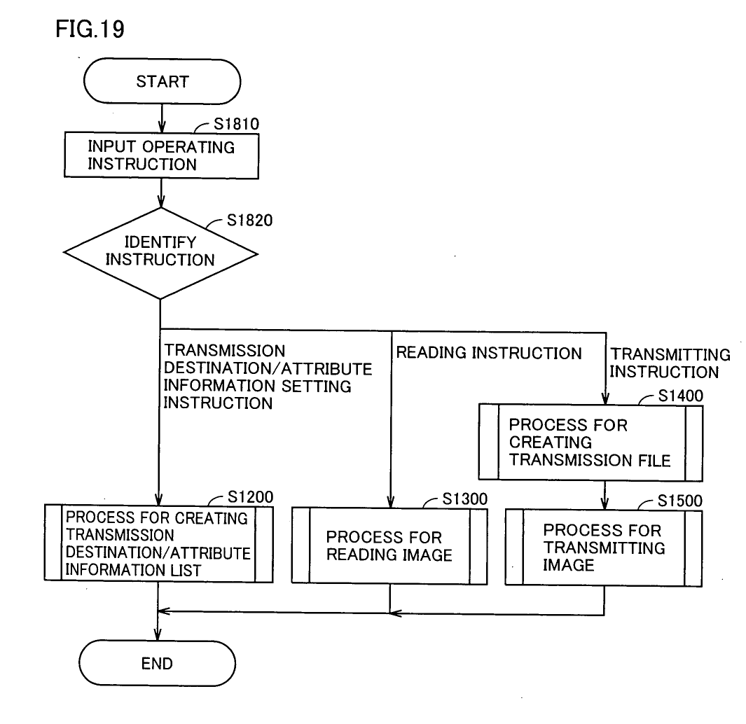

FIG. 19 is a flowchart which shows a procedure of processes executed by CPU 110 for the purpose of generating a file for transmission at the time of input of a file transmitting instruction. It is to be noted that the same processes as the aforementioned processes are denoted by the same step numbers; therefore, description thereof will not be repeated herein.

If the inputted instruction is the one for transmitting a file, the process proceeds to step S1400. In step S1400, CPU 110 executes a transmission file creating process. Thereafter, in step S1500, CPU 110 transmits the generated file to a designated transmission destination.

In this case, a user can transmit an image file at any timings. Accordingly, an image file generated once can be processed. Further, the image file can be subjected to a process which is not defined in the procedure of the process shown in FIG. 19. Thus, it is possible to freely change a mode of an image file to be transmitted.

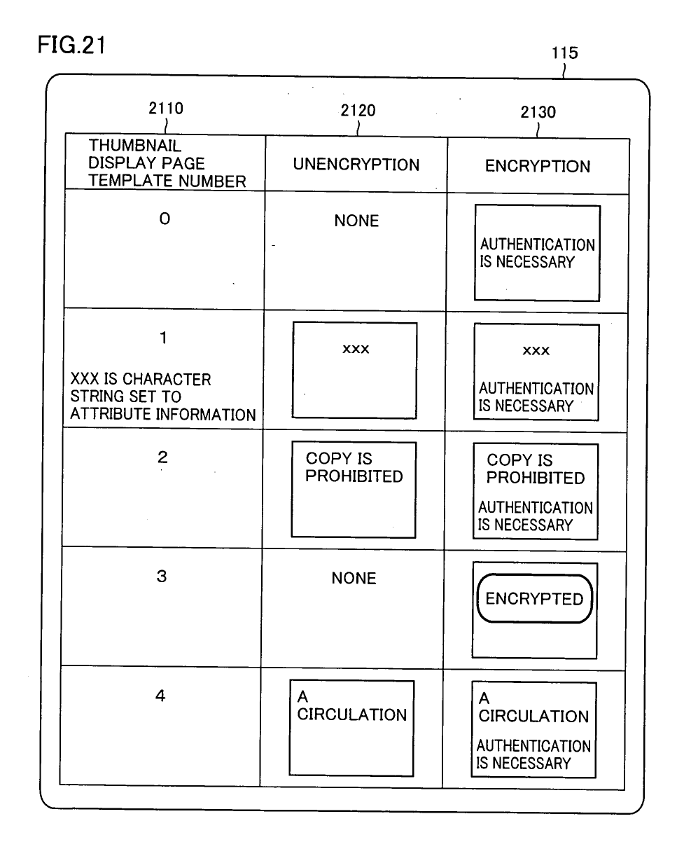

With reference to FIGS. 20 and 21, description will be further given of the data structure of image processing device 100 according to this embodiment. FIG. 20 shows a format of a file generated in the work RAM.

Work RAM 115 temporarily stores data generated by CPU 110, more specifically, stores the data in a volatile manner. The file to be stored contains a header 2010 and a text image 2020. An address indicates a data storage position from the leading of the file. With respect to a thumbnail image of a page for thumbnail display and the text image, addresses thereof are changed in accordance with an image size. Accordingly, it is not always necessary to fix these addresses, and these address may be variable. Herein, an address and data are associated with each other.

Header 2010 contains the authentication level of a file, the name of the file, the total number of pages of the file, the number of bytes of a header, the number of bytes of a text image, data representing presence/absence of a page for thumbnail display, data representing presence/absence of an image (thumbnail image) of the page for thumbnail display, data representing whether or not the file is encrypted, data representing whether or not the file has attribute information, attribute information, and data of the page for thumbnail display representing the attribute information.

Text image 2020 is image data generated in advance for transmission. A generated file is stored as shown in FIG. 20, for example. In the case where a plurality of files are generated and there exist files which are not transmitted yet, files to be newly generated may be sequentially created in a different area from that for the already generated files with the use of a format similar to the format shown in FIG. 20. In this case, information for specifying the generated files are provided with numbers which are sequential numbers in file names stored in header 2010, so that files generated at a different timing can be also identified.

FIG. 21 shows a structure of data temporarily stored in work RAM 115 for the purpose of selecting a page for thumbnail display. Work RAM 115 corresponds to, for example, template storage part 418 shown in FIG. 4. Work RAM 115 includes areas 2110 to 2130 each of which stores data.

Page template numbers for thumbnail display are stored in area 2110. Two types, i.e., page template numbers for unencryption and page template numbers for encryption are prepared in advance. In the case where a file is transmitted without encryption, data for displaying a thumbnail of the file is stored in area 2120.

A page for thumbnail display, which is provided in the case where the file is transmitted with encryption, is stored in area 2130. This data contains character data (e.g., “authentication is necessary”, “copy is prohibited”) prepared in advance. In the case where attribute information contains such a specific character string, the image of the page for thumbnail display is displayed while containing the character string. In step S1640 shown in FIG. 16 and step S1750 shown in FIG. 17, CPU 110 can select the page template number for thumbnail display shown in FIG. 21.

Image processing device 100 described above can be realized as a copy machine or a facsimile transmission/reception machine usable in a network environment and, also, can be realized by a computer system.

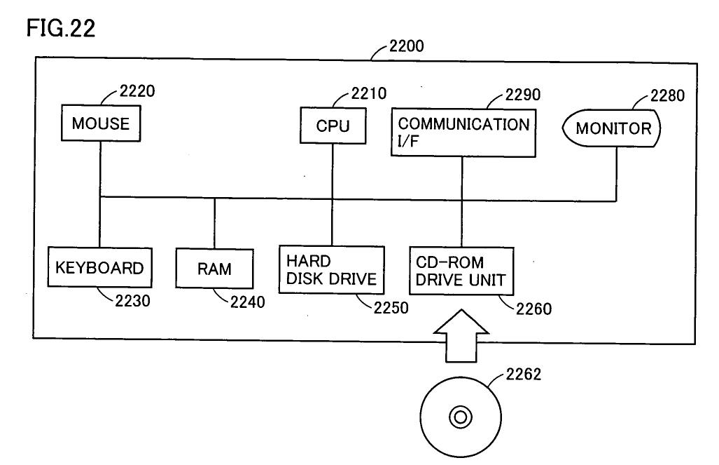

With reference to FIG. 22, description will be given of a computer system 2200 for realizing image processing device 100 according to this embodiment. FIG. 22 is a block diagram which shows a hardware configuration of computer system 2200.

Computer system 2200 includes a CPU 2210, a mouse 2220 and a keyboard 2230 each of which accepts input of an instruction, a RAM 2240 which temporarily stores data generated by a process executed in accordance with inputted data or a program, a hard disk drive 2250 which can store data in a nonvolatile manner, a CD-ROM (Compact Disk-Read Only Memory) drive unit 2260, a monitor 2280, and a communication IF (Interface) 2290, which are mutually connected to each other via a data bus. A CD-ROM 2262 can be loaded into CD-ROM drive unit 2260.

Processes in computer system 2200 functioning as image processing device 100 are realized by a program product executed by CPU 2210 and the respective pieces of hardware that operate in accordance with execution of the program product. Such a program product is stored in RAM 2240 or hard disk drive 2250 in advance in some cases or, alternatively, is stored in CD-ROM 2262 or other data recording medium and distributed. Data stored in the data recording medium is read from the data recording medium by CD-ROM drive unit 2260 or other reading unit, and is temporarily stored in hard disk drive 2250.

The program product is read from RAM 2240 or hard disk drive 2250, and is executed by CPU 2210. The hardware itself of computer system 2200 shown in FIG. 22 is typical. Accordingly, it can be said that the essential portion of the present invention is the program product stored in RAM 2240, hard disk drive 2250, CD-ROM 2262 or other recording media. It is to be noted that operations of the respective pieces of hardware of computer system 2200 are well known; therefore, detailed description thereof will not be repeated.

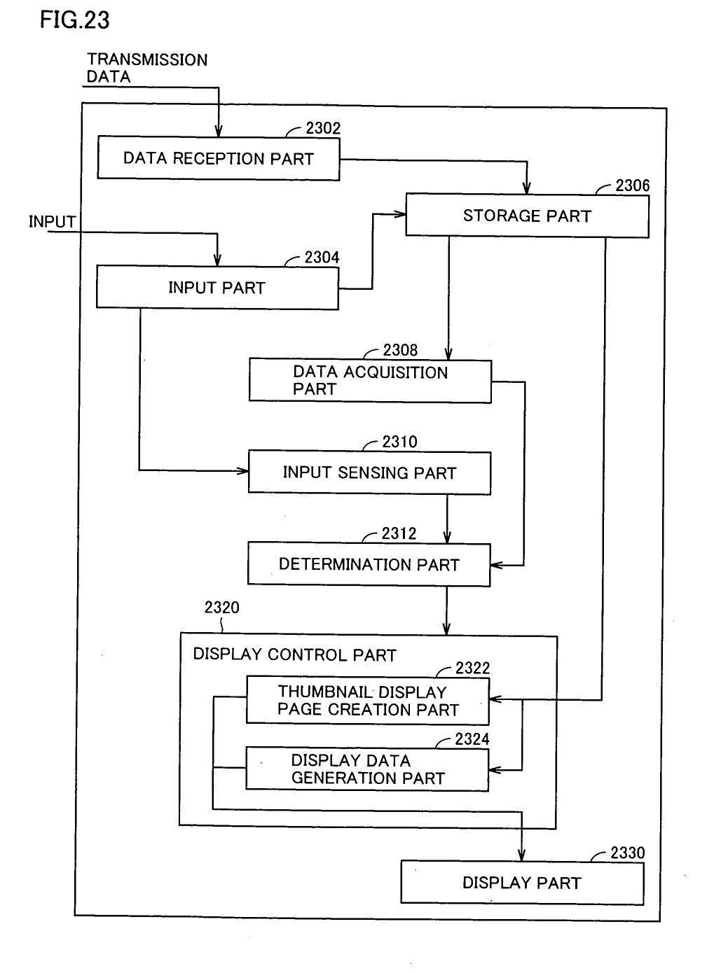

With reference to FIG. 23, description will be given of image display devices 150 and 160 each of which receives a file from image processing device 100 according to this embodiment. FIG. 23 is a block diagram which shows a functional configuration of each of image display devices 150 and 160.

Image display device 150 or 160 includes a data reception part 2302 which accepts input of transmission data, an input part 2304 which accepts input by a user of image display device 150 or 160, and a storage part 2306 which stores the received data and the data that input thereof is accepted.

Image display device 150 or 160 further includes a data acquisition part 2308 which acquires the data stored in storage part 2306, an input sensing part 2310 which senses input to input part 2304, a determination part 2312 which determines a display mode of a file received on the basis of the data acquired by data acquisition part 2308 and an instruction sensed after input, a display control part 2320 which generates data for displaying an image based on the received data on the basis of the result of determination by determination part 2312, and a display part 2330 which displays an image on the basis of the data generated by display control part 2320.

Display control part 2320 includes a thumbnail display page creation part 2322 which generates data for displaying a page of a file as a thumbnail image on the basis of the data stored in storage part 2306, and a display data generation part 2324 which generates data for display representing details of data received on the basis of the data stored in storage part 2306. When the data displayed by thumbnail display page creation part 2322 is sent to display part 2330, display part 2330 displays a thumbnail image of a page.

Similar to image processing device 100, each of image display devices 150 and 160 according to this embodiment can be realized by a computer system. In this case, the computer system is, for example, a typical system having the configuration shown in FIG. 22. Therefore, description will be given of image display devices 150 and 160 with the aid of the configuration.

The control structure of image display device 150 or 160 according to this embodiment has been described with reference to FIG. 6. Therefore, description thereof will not be repeated herein.

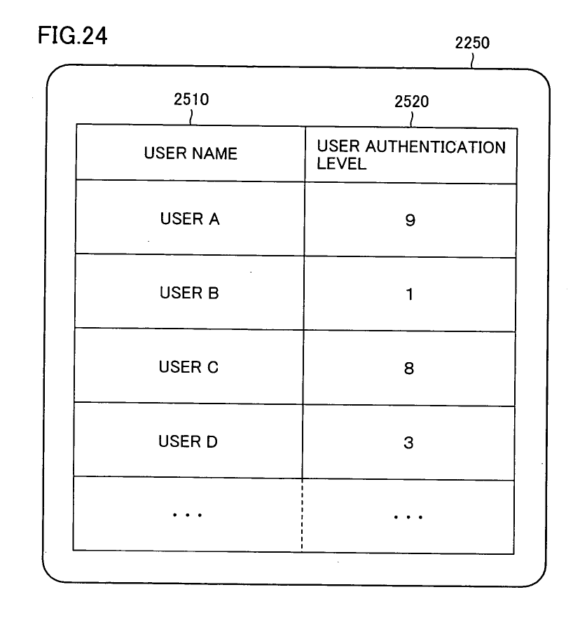

With reference to FIG. 24, description will be given of a data structure of each of image display devices 150 and 160. FIG. 24 shows a data storage mode in hard disk drive 2250 of computer system 2200 functioning as image display device 150 or 160. Hard disk drive 2250 includes areas 2510 and 2520 each of which stores data.

Data for identifying respective users of image display devices 150 and 160 are stored in area 2510. Levels preset for the purpose of authenticating the respective users are stored in area 2520. These data are mutually associated with each other. Herein, the data stored in hard disk drive 2250 may be stored in CD-ROM 2262 or another nonvolatile recording medium.

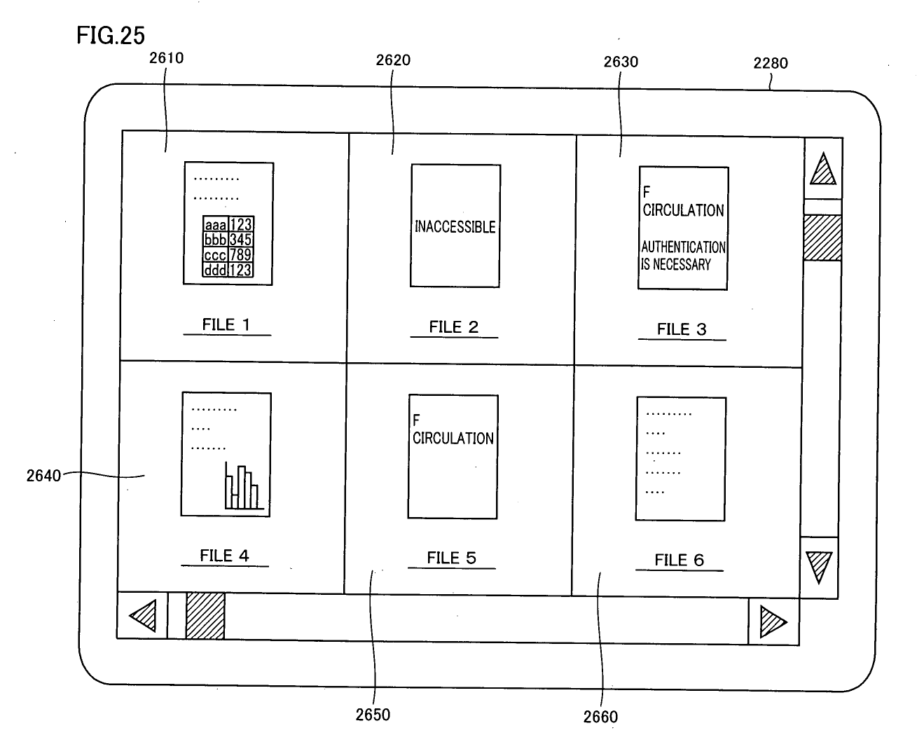

With reference to FIG. 25, description will be given of a display mode of each of image display devices 150 and 160 according to this embodiment. FIG. 25 shows display of a thumbnail image on monitor 2280 of computer system 2200 functioning as image display device 150 or 160.

When computer system 2200 receives a plurality of files from image processing device 100, monitor 2280 displays thumbnail images of the respective received files. For example, monitor 2280 displays a first file 2610, a second file 2620, a third file 2630, a fourth file 2640, a fifth file 2650 and a sixth file 2660 on its display area.

First file 2610, fourth file 2640 and sixth file 2660 have no restriction of access to the respective files and, also, have no restriction of viewing. Consequently, details of a first page are displayed as a thumbnail image of each file.

Second file 2620 permits only access by a specific user. Therefore, in the case where second file 2620 is displayed as a thumbnail image, only an image displaying “inaccessible” is shown.

Third file 2630 has restriction of access to the file. Third file 2630 further contains, as an image page for thumbnail display, information representing that viewing thereof is permitted to only a user belonging to a specific group (i.e., “F group circulation”).

Fifth file 2650 contains information representing that viewing thereof is permitted to only a user belonging to a specific group (i.e., “F group circulation”). However, access to the file is not restricted. Consequently, display for notifying that restriction of access exists (i.e., “authentication is necessary”) as shown in FIG. 3 is not displayed on fifth file 2650.

Herein, the image display mode of the image display device 150 or 160 according to this embodiment is not particularly limited to the mode shown in FIG. 25. In the case where files larger in number than the files which can be displayed on the display area are already received as shown in FIG. 25, the other files can be displayed by scrolling the display of the screen. In addition, the order of displaying the files may be pursuant to, for example, the one other than the names of the files or the reception times of the files, as shown in FIG. 25. For example, files belonging to the same group may be collectively displayed. As a result, the user of image display device 150 or 160 can collectively perform a process for viewing files belonging to the specific group; therefore, it is possible to improve convenience of image display devices 150 and 160.

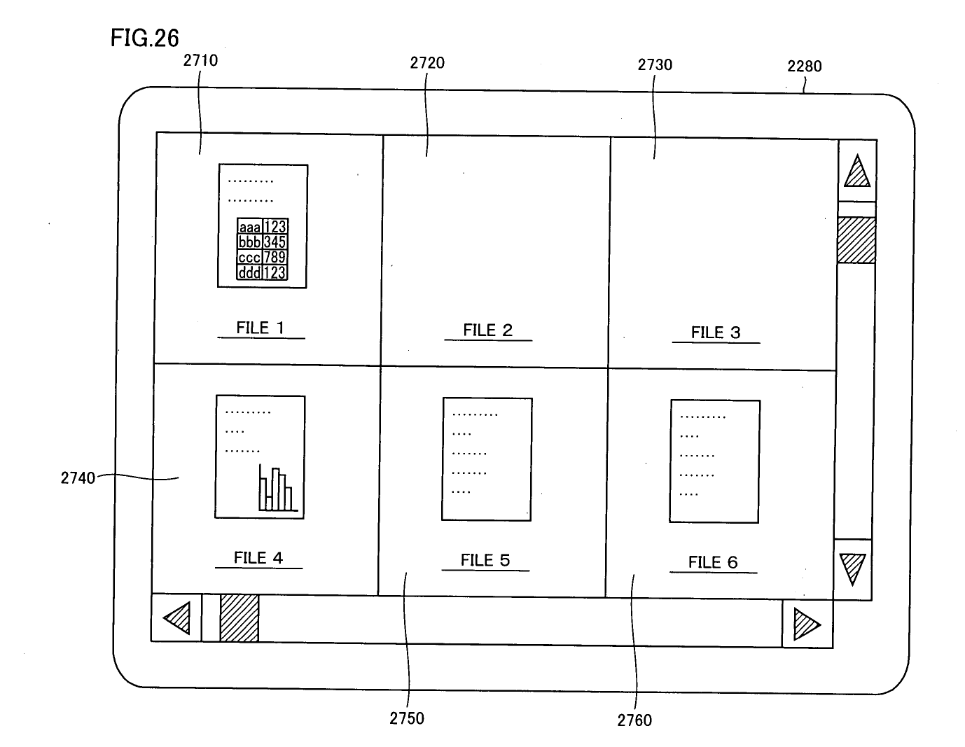

With reference to FIG. 26, description will be given of a file display mode in a conventional image display device. FIG. 26 shows a screen displayed by an image display device when an image file is generated by a conventional mode and is received by the image display device. Herein, a first file 2710, a fourth file 2740, a fifth file 2750 and a sixth file 2760 have no restriction of access, respectively. Accordingly, as for these files, an initial page of each file is displayed as a thumbnail image. On the other hand, a second file 2720 and a third file 2730 are set in such a manner that access can be permitted to only specific users of the respective files. In this case, since monitor 2280 is not subjected to an authenticating process for access, images of the received files cannot be displayed on monitor 2280. Consequently, a user of the image display device cannot recognize a type of the file at all.

As described above, as for an image to be transmitted, image processing device 100 according to this embodiment generates an image (thumbnail image) for representing an attribute of a file of the image on the basis of attribute information prepared in advance, attaches the generated image to the file of the image, and transmits the file to a designated transmission destination. The transmission destination which receives the file, that is, image display device 150 or 160 displays a thumbnail image of the file.

In the case where the file is encrypted herein, image display device 150 or 160 displays a thumbnail image including an image for notifying necessity of an authenticating process. On the other hand, in the case where the file is unencrypted, image display device 150 or 160 displays a thumbnail image including attribute information.

Thus, a person who views an image file can readily estimate a type of the file before opening the file. Moreover, in the case of an encrypted file, a fact that the file is encrypted is displayed. Similarly, in the case of a file instructing viewing in a specific group, a fact that the file is viewed in the specific group is displayed. Thus, the person who views the image file can input a password without confirming details of the file and can view the file; therefore, he/she can readily realize file management. In addition, since operation instructing information such as a viewing instruction is displayed, it is possible to instruct a receiver of encouraging viewing.

In the case where a data amount of an image file is large, sometimes it takes longer times to develop the file. However, according to this embodiment, a thumbnail image is displayed prior to development of a file; therefore, a person who views the file can promptly grasp the details of the file.

### Second Embodiment

Hereinafter, description will be given of a second embodiment of the present invention. An image processing device and an image display device according to this embodiment are different from image processing device 100 and image display devices 150 and 160 according to the first embodiment in the following point. That is, according to this embodiment, the image processing device transmits an image file without giving data for thumbnail display and, conversely, the image display device generates data for thumbnail display in accordance with the file.

The different point in this embodiment is realized in such a manner that the processes in the image processing device according to the first embodiment are not executed and a specific process is additionally executed in the image display device. The respective devices have the same hardware structure as those in the first embodiment. In one aspect, the image processing device or the image display device is realized by the computer system shown in FIG. 22. Accordingly, description of the hardware configuration will not be repeated herein.

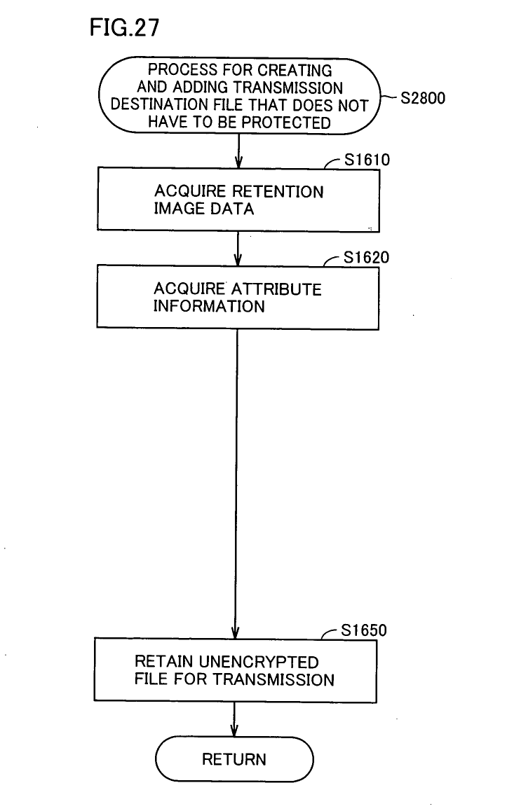

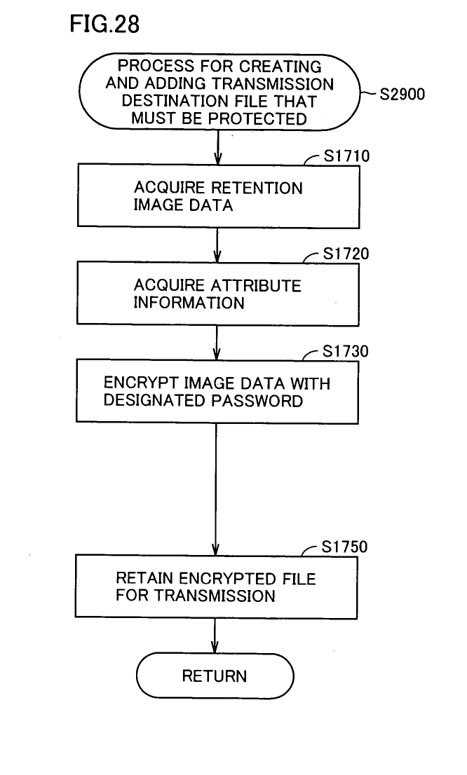

With reference to FIGS. 27 and 28, description will be given of a control structure of the image processing device according to this embodiment. FIG. 27 is a flowchart which shows a procedure of processes executed by CPU 110 for the purpose of generating a transmission destination file that does not have to be protected. FIG. 28 is a flowchart which shows a procedure of processes executed by CPU 110 for the purpose of generating a transmission destination file that must be protected.

With reference to FIG. 27, the processes in step S2800 is equal to those (step S1600) shown in FIG. 16, from which steps S1630 and S1640 are removed. Therefore, description of the remaining processes will not be repeated herein.

With reference to FIG. 28, the processes in step S2900 is equal to those (step S1700) shown in FIG. 17, from which step S1740 is removed. Therefore, description of the remaining processes will not be repeated herein.

When the image processing device according to this embodiment executes the process shown in FIG. 14, the processes (S2800) shown in FIG. 27 or the processes (S2900) shown in FIG. 28 are executed. Thus, the image processing device transmits an image file to the image display device without giving a page for thumbnail display. Consequently, the image display device creates a page for thumbnail display, and executes a process for displaying the page for thumbnail display together with an image file.

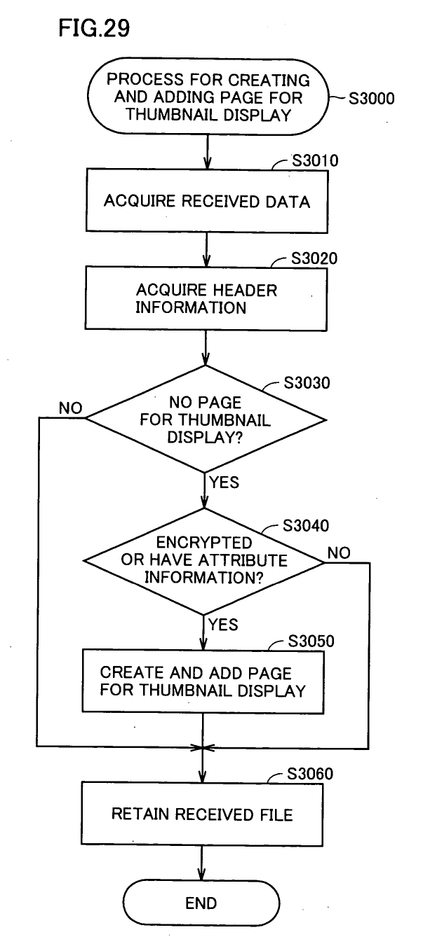

With reference to FIG. 29, description will be given of a control structure of the image display device according to this embodiment. Herein, description will be given with the aid of computer system 2200 shown in FIG. 22. FIG. 29 is a flowchart which shows a procedure of processes executed by CPU 2210 for the purpose of creating a page for thumbnail display.

In step S3010, CPU 2210 acquires the received data. In step S3020, CPU 2210 acquires header information of the received data. In step S3030, CPU 2210 determines whether or not the received data has a page for thumbnail display on the basis of data contained in the header information. If the data has no page for thumbnail display (YES in step S3030), the process proceeds to step S3040. If not (NO in step S3030), the process proceeds to step S3060.

In step S3040, CPU 2210 determines whether or not the received data is encrypted or whether or not the received data has attribute information on the basis of the data contained in the header information. If the received data is encrypted or has attribute information (YES in step S3040), the process proceeds to step S3050. If not (NO in step S3040), the process proceeds to step S3060.

In step S3050, CPU 2210 creates a page for thumbnail display corresponding to the received data on the basis of the data contained in the header information, and adds the page to the received data. In step S3060, CPU 2210 retains the received data in a memory (e.g., hard disk drive 2250 or RAM 2240).

As described above, the image processing device according to this embodiment transmits an image file to a designated transmission destination without adding attribute information of a file and creating and adding a page for thumbnail display. In the case where the received file contains no data of a page for thumbnail display, the image display device generates data for thumbnail display with the use of attribute information data prepared in advance in the file header part, and associates the data with the received file. This process is executed by the thumbnail display page creation part shown in FIG. 23. Since information about details of the file can be notified at the reception side, a person who views the image file can readily understand the details.

### Third Embodiment

Hereinafter, description will be given of a third embodiment of the present invention. An image processing device according to this embodiment is different from the one according to each of the aforementioned embodiments in the following point. That is, the image processing device according to this embodiment has a function of collectively transmitting a plurality of files on the basis of the selection of the files. The difference of the function described hereinafter is based on a fact that a process for realizing the function is executed for the image processing device according to each of the aforementioned embodiments. The image processing device has the same hardware configuration as those in the aforementioned embodiments; therefore, description thereof will not be repeated herein.

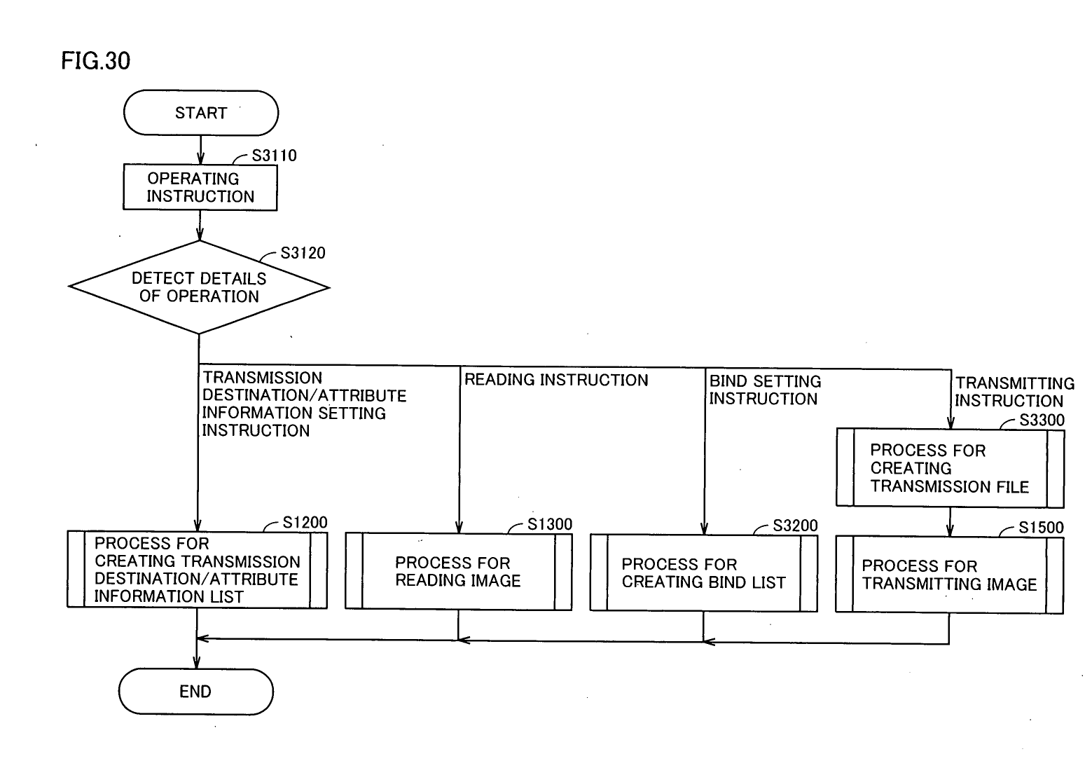

With reference to FIG. 30, description will be given of a control structure of the image processing device according to this embodiment. FIG. 30 is a flowchart which shows a procedure of processes executed by CPU 110 of the image processing device. It is to be noted that the same processes as those in the aforementioned processes are denoted by the same step numbers; therefore, description thereof will not be repeated herein.

In step S3110, CPU 110 accepts operating instructions on the basis of input through operation panel 114. In step S3120, CPU 110 detects details of the inputted operation. The operation to be detected includes a transmission destination/attribute information setting instruction, an image reading instruction, a bind setting instruction for binding a plurality of files to each other, a file transmitting instruction, and the like.

If the inputted instruction is the one for setting transmission destination/attribute information, the process proceeds to step S1200. If the inputted instruction is an image reading instruction, the process proceeds to step S1300. If the inputted instruction is a bind setting instruction, the process proceeds to step S3200. If the inputted instruction is a transmitting instruction, the process proceeds to step S3300.

In step S3200, CPU 110 executes a process for creating a bind list, which will be described later. Upon execution of this process, a list describing files to be transmitted is generated.

In step S3300, CPU 110 executes a process for creating a transmission file, which will be described later. Upon execution of this process, a transmission file containing a file that must be protected or a file that does not have to be protected is generated.

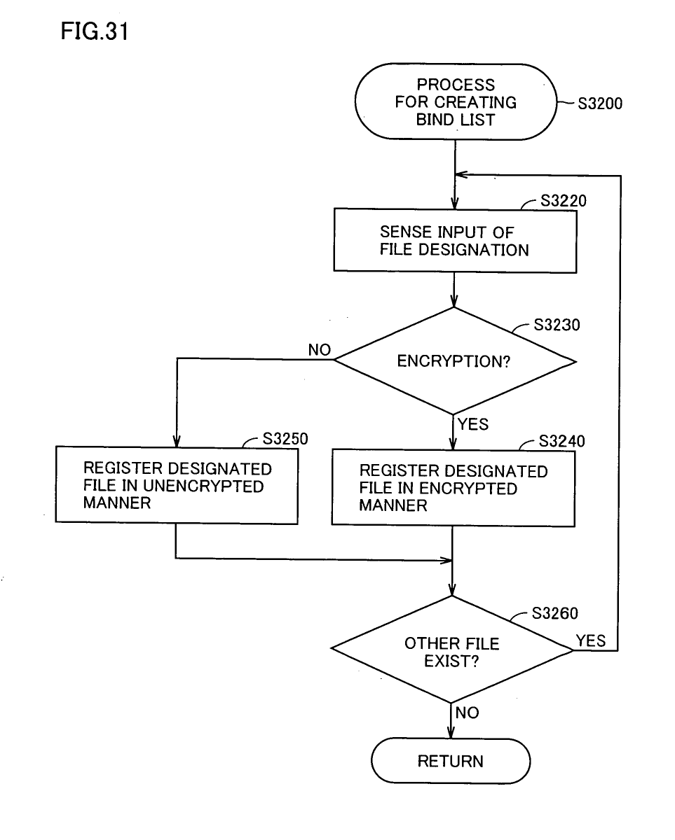

With reference to FIGS. 31 to 34, description will be further given of the control structure of the image processing device according to this embodiment. Also herein, description will be given with the aid of computer system 2200 shown in FIG. 22. FIG. 31 is a flowchart which shows a procedure of processes executed by CPU 110 for the purpose of creating a bind list.

In step S3220, CPU 110 senses input of file designation. In step S3230, CPU 110 determines whether or not a designated file is encrypted. This determination is performed, for example, on the basis of whether or not data for encryption is added to the file designated on the basis of input through operation panel 114. If the file is encrypted (YES in step S3230), the process proceeds to step S3240. If not (NO in step S3230), the process proceeds to step S3250.

In step S3240, CPU 110 executes a predetermined encrypting process, thereby retaining a designated file. In step S3250, CPU 110 stores the designated file in a prescribed area (e.g., an area reserved in work RAM 115) without encrypting the file.

In step S3260, CPU 110 determines whether or not other file is designated. If the other file is designated (YES in step S3260), the process proceeds to step S3320. If not (NO in step S3260), the process is finished.

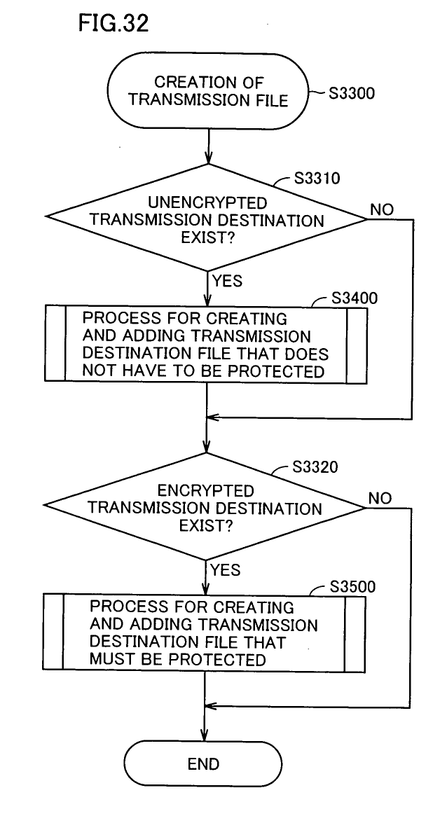

FIG. 32 is a flowchart which shows a procedure of processes executed by CPU 110 for the purpose of creating a transmission file.

In step S3310, CPU 110 determines whether or not there exists a transmission destination to which an unencrypted file can be transmitted. If such a transmission destination exists (YES in step S3310), the process proceeds to step S3400. If not (NO in step S3310), the process proceeds to step S3320.

In step S3400, CPU 110 executes a “process for creating and adding a transmission destination file that does not have to be protected” which will be described later. Upon execution of this process, an unencrypted file is generated.

In step S3320, CPU 110 determines whether or not there exists a transmission destination which requests transmission of the encrypted file. If such a transmission destination exists (YES in step S3320), the process proceeds to step S3600. If not (NO in step S3320), the process is finished.

In step 3600, CPU 110 executes a “process for creating and adding a transmission destination file that must be protected” which will be described later. Upon execution of this process, a file encrypted with a password designated in advance is generated.

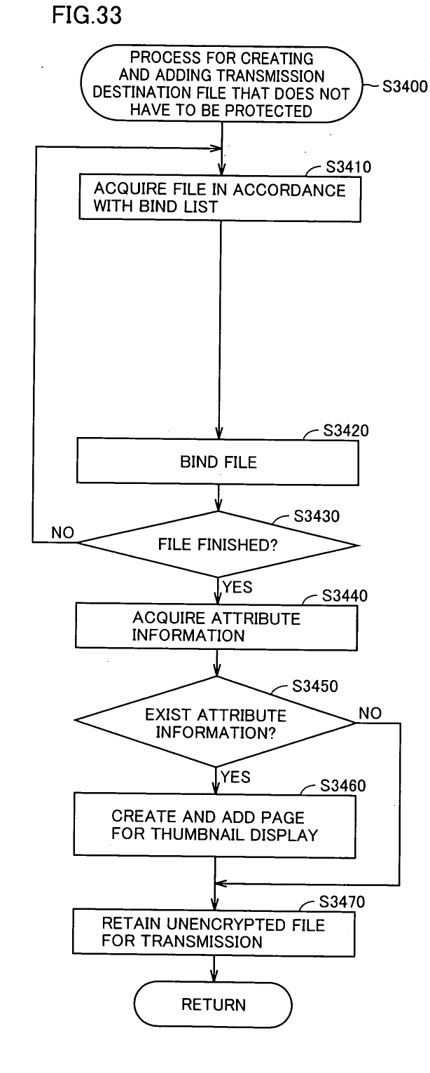

FIG. 33 is a flowchart which shows a procedure of processes executed by CPU 110 for the purpose of creating a transmission destination file that does not have to be protected.

In step S3410, CPU 110 acquires a file designated in accordance with the bind list which has been already set. More specifically, each file is temporarily stored in the area reserved in work RAM 115. Instep S3420, CPU 110 binds the acquired files to each other. Thus, a plurality of files are bound to each other, so that one file is generated.

In step S3430, CPU 110 determines whether or not the binding process is finished for all files. If this process is finished (YES in step S3430), the process proceeds to step S3440. If not (NO in step S3430), the process returns to step S3410.

In step S3440, CPU 110 acquires attribute information from user data memory 111. In step S3450, CPU 110 determines whether or not there exists attribute information to be added to the file. If such attribute information exists (YES in step S3450), the process proceeds to step S3460. If not (NO in step S3450), the process proceeds to step S3470.

In step S3460, CPU 110 creates a page for thumbnail display, and adds the page to a file generated by the binding process. In step S3470, CPU 110 stores the generated file (i.e., an unencrypted file for transmission) in work RAM 115 or user data memory 111.

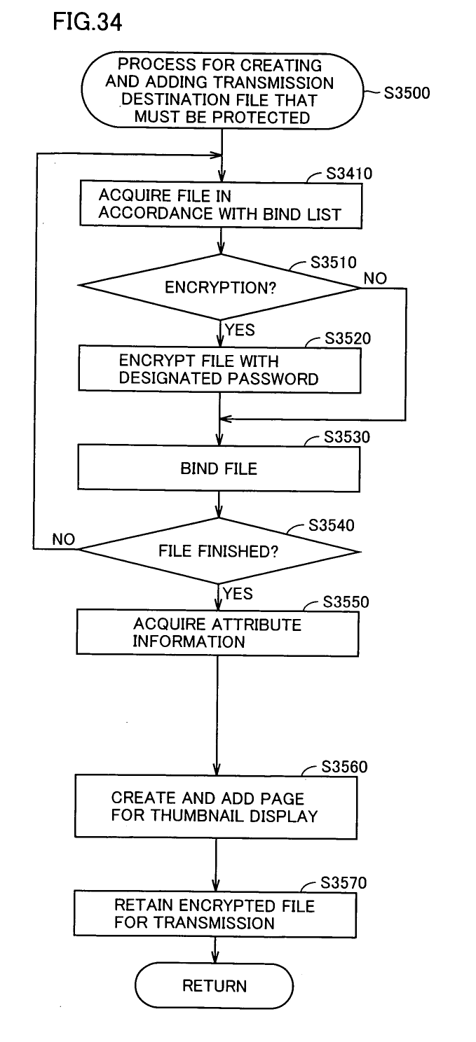

FIG. 34 is a flowchart which shows a procedure of processes executed by CPU 110 for the purpose of creating a transmission destination file that must be protected. It is to be noted that the same processes as the aforementioned processes are denoted by the same step numbers; therefore, description thereof will not be repeated herein.

In step S3510, CPU 110 determines whether or not a file acquired in accordance with the bind list must be encrypted. This determination is performed based on, for example, details indicating attribute information associated with each file. If the file must be encrypted (YES in step S3510), the process proceeds to step S3520. If not (NO in step S3510), the process proceeds to step S3530.

In step S3520, CPU 110 executes a predetermined encrypting process to the acquired file with the use of a password designated in advance. A mode of the encrypting process is not particularly limited.

In step S3530, if the acquired file is encrypted, CPU 110 binds the file, and if the acquired file is unencrypted, CPU 110 binds an original file. In step S3540, CPU 110 determines whether or not a process for all files is finished. If the process is finished (YES in step S3540), the process proceeds to step S3550. If not (NO is step S3540), the process returns to step S3510.

In step S3550, CPU 110 acquires attribute information which is stored in user data memory 111 and is associated with each file. In step S3560, CPU 110 creates and adds a page for thumbnail display on the basis of the acquired information. In step S3570, CPU 110 stores the generated file (i.e., an encrypted file for transmission) in work RAM 115 or user data memory 111.

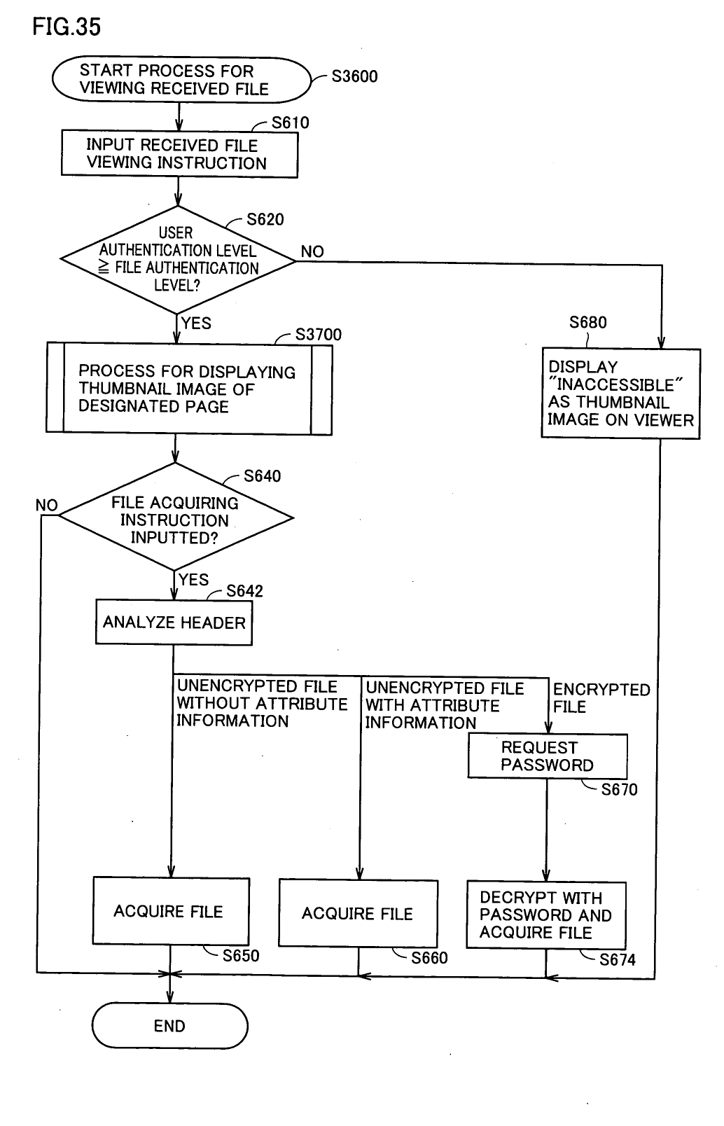

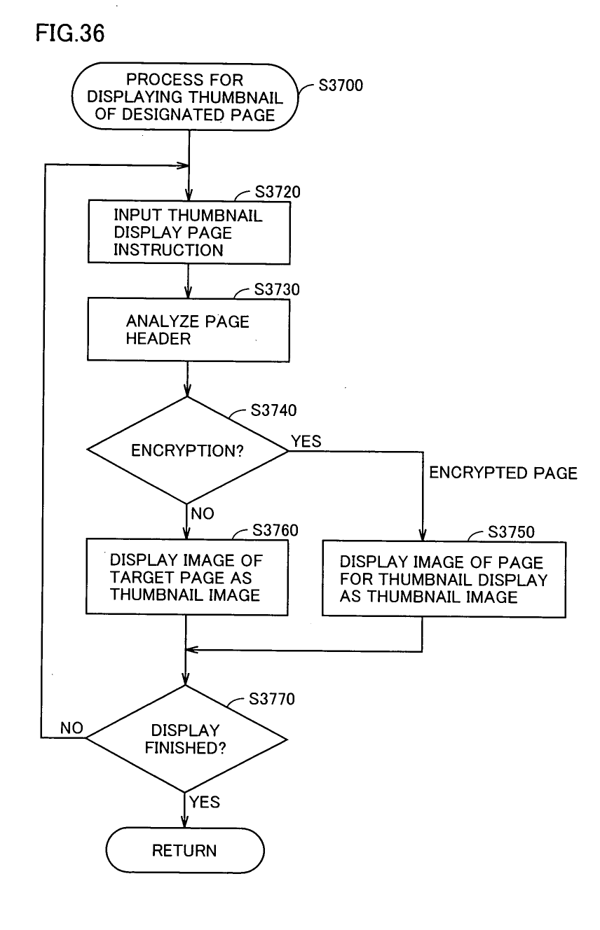

With reference to FIGS. 35 and 36, description will be given of a control structure of the image display device according to this embodiment. Also herein, on the assumption that the image display device is realized by computer system 2200 shown in FIG. 22, description will be given with the aid of the configuration of computer system 2200. FIG. 35 is a flowchart which shows a procedure of processes (S3600) executed by CPU 2210. It is to be noted that the same processes as the aforementioned processes are denoted by the same step numbers; therefore, description thereof will not be repeated herein.

In step S620, CPU 2210 determines whether or not a user authentication level is equal to or more than a file authentication level. If the user authentication level is equal to or more than the file authentication level (YES in step S620), the process proceeds to step S3700. If not (NO in step S620), the process proceeds to step S680.

In step S3700, CPU 2210 executes a “process for displaying a thumbnail image of a designated page” which will be described later. Upon execution of this process, a thumbnail image of a designated page is displayed.

FIG. 36 is a flowchart which shows a procedure of processes executed by CPU 2210 for the purpose of displaying a thumbnail image.

In step S3710, CPU 2210 accepts input of a designated page thumbnail displaying instruction. In step S3720, CPU 2210 accepts input for file selection.

In step S3730, CPU 2210 analyzes a page header of a selected file in accordance with a criterion prepared in advance. In step S3740, CPU 2210 determines whether or not the file is encrypted, on the basis of the analysis result of the page header. If the file is encrypted (YES in step S3740), the process proceeds to step S3750. If not (NO in step S3740), the process proceeds to step S3760.

In step S3750, CPU 2210 displays an image of a page for thumbnail display of the file as a thumbnail image. In step S3760, CPU 2210 displays an image of a designated page as a thumbnail image.

In step S3770, CPU 2210 determines whether or not the thumbnail display is finished. This determination is performed by detecting presence/absence of input of an instruction for finishing display. If CPU 2210 determines that the thumbnail display is finished (YES in step S3770), the process is finished. If not (NO in step S3770), the process returns to step S3720.

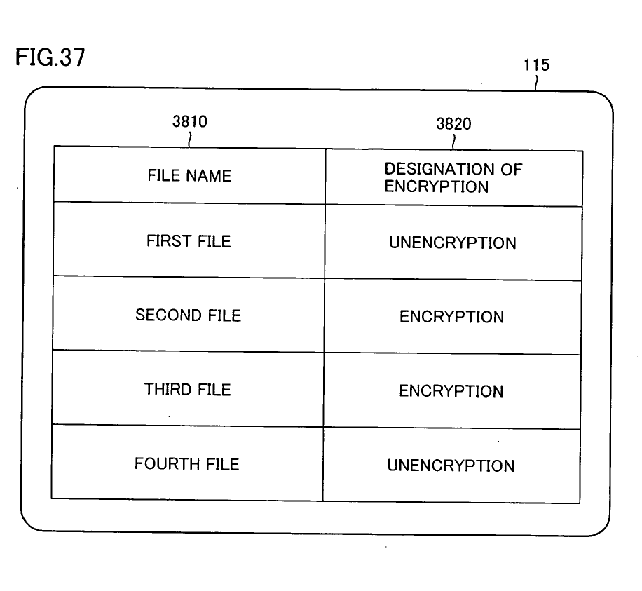

With reference to FIG. 37, description will be given of a data structure of the image processing device according to this embodiment. FIG. 37 shows a mode of a bind list in work RAM 115. Work RAM 115 includes an area 3810 which stores file names, and an area 3820 which stores data representing whether or not encryption is designated.

For example, in a first file and a fourth file, encryption is not designated (area 3820). In this case, each file is bound to each other without encryption. On the other hand, in a second file and a third file, encryption is designated, respectively. Accordingly, these files are bound to each other after encryption.

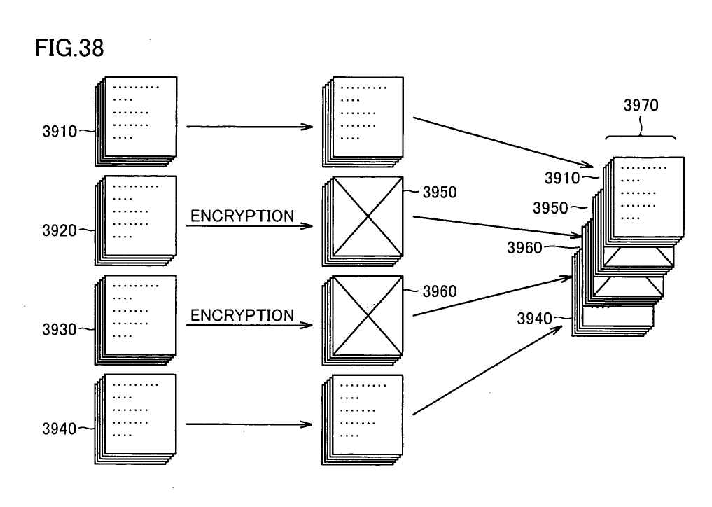

With reference to FIG. 38, description will be given of a bind list in the image processing device according to this embodiment. FIG. 38 shows a mode of generating a file from the four files shown in FIG. 37.

Four files, that is, a first file 3910, a second file 3920, a third file 3930 and a fourth file 3940 are respectively designated as a transmission target. As shown in FIG. 37, first file 3910 and fourth file 3940 are not designated as a transmission target. On the other hand, second file 3920 and third file 3930 are designated as a transmission target.

Thus, when CPU 110 executes a process for the four files on the basis of designation for each file, first file 3910 and fourth file 3940 stay as they are. On the other hand, second file 3920 is converted to an encrypted file 3950 by a predetermined encrypting process. Similarly, third file 3930 is converted to a file 3960 by the encrypting process. These files are stored in an area temporarily reserved in work RAM 115.

CPU 110 sequentially binds these files to each other to generate a file 3970 as a bound file. In this case, file 3970 contains encrypted files 3950 and 3960 next to unencrypted file 3910, and contains unencrypted file 3940 next to encrypted files 3950 and 3960. In this case, the order of the files in file 3970 is pursuant to a predetermined criterion, for example, an order designated at the time of generating a bind list, or an ascend/descend order of file names.

Herein, the configuration of file 3970 is not limited to the configuration shown in FIG. 38. For example, file 3970 may contain unencrypted files in its former half and encrypted files in its latter half, and vice versa. In this case, a person who view file 3970 can sensuously recognize the importance of each file in accordance with the sequence of each file and, therefore, can clarify recognition with respect to the file at the time of viewing.

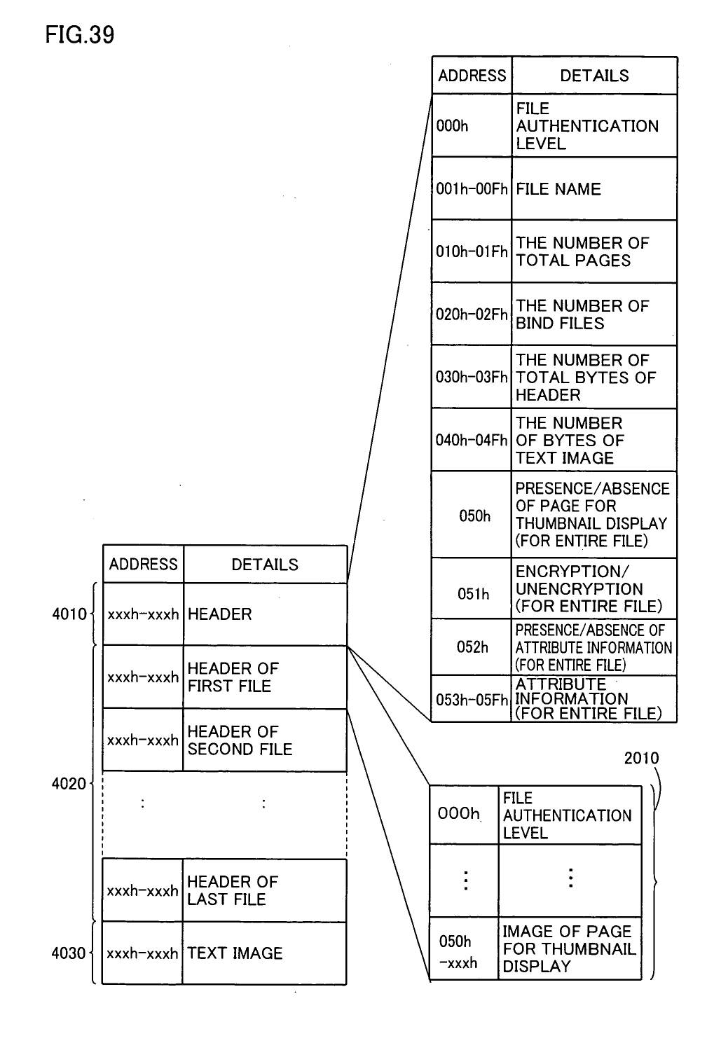

With reference to FIG. 39, description will be given of a configuration of a file generated by the image processing device according to this embodiment. FIG. 39 shows a format of a file. This file contains a header 4010, a page header 4020 and a text image 4030.

Header 4010 contains, as items of header information, the authentication level of a file, the name of the file, the total number of pages of the file, the number of bytes of a header, the total number of bytes of a page header, the number of bytes of a text image, data representing presence/absence of a page for thumbnail display, data representing whether or not encryption is made, data representing presence/absence of attribute information for each bound file, and attribute information for each bound file.

Page header 4020 contains a header of a first page, a header of a second page . . . and a header of a last page in this order. The header of each page contains a page number, the number of bytes of the page, and data representing whether or not the page is encrypted.

The file having the aforementioned configuration is stored in an area reserved for each item. Such an area is specified by an address from the leading of the file as shown in FIG. 39.

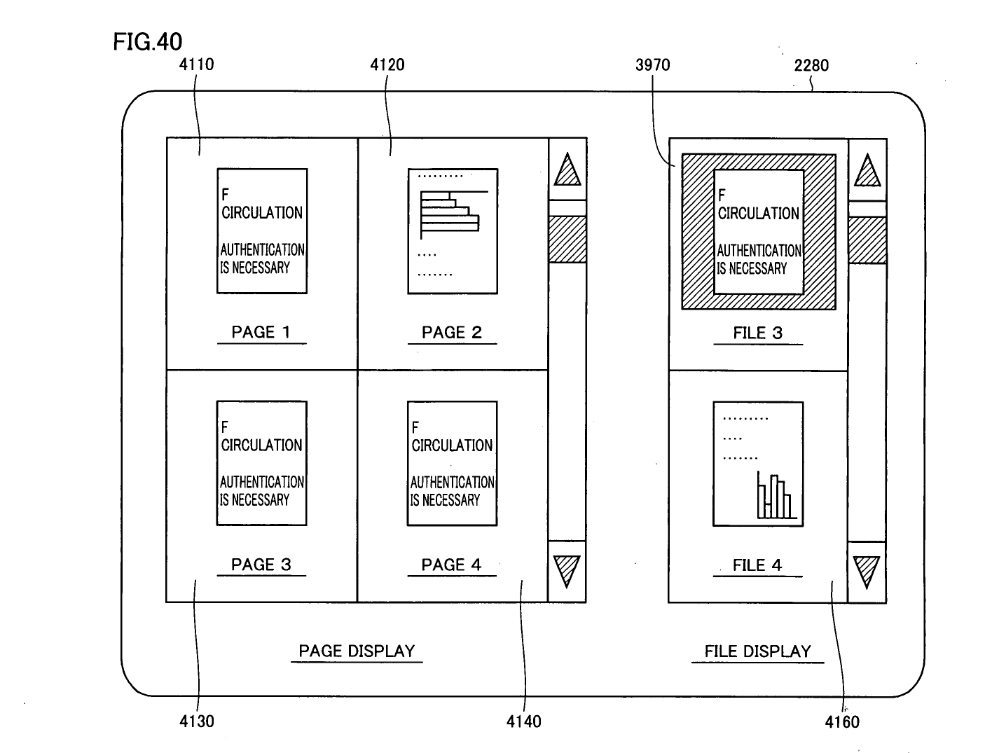

With reference to FIG. 40, description will be given of a file display mode in the image display device according to this embodiment. FIG. 40 shows display of a file on monitor 2280 of the image display device.

When the image processing device transmits a file generated by binding a plurality of files to each other to the image display device, the image display device displays an area which displays the leading of each file, and an area which displays a page contained in the file.

As shown in FIG. 40, thumbnail images of third and fourth file attributes among the bound four files shown in FIG. 39 are displayed as “file display”. For example, images 4110, 4120, 4130 and 4140 are displayed in accordance with selection of third file 4150. These images correspond to the thumbnail images of the first pages of the respective files contained in file 3970 shown in FIG. 38. Herein, as for the first file, third file and fourth file of file 3970, only attribute information is displayed. Accordingly, it is clear that access to a file corresponding to the first file, a file corresponding to the third file and a file corresponding to the fourth file is restricted.

On the other hand, access to the second file is not restricted. More specifically, a thumbnail image of a first file of a file corresponding to the second file is displayed as image 4120. Accordingly, a person who views file 3970 can view a thumbnail image of a text corresponding to the second file as it is, without performing an authenticating process based on a preset password.

In the case where such display is made, a user of the image display device selects File 4 (4160) in place of File 3 (3970) in monitor 2280. Herein, since access to File 4 (4160) is not restricted, pages contained in File 4 (4160) are displayed as thumbnail images of the pages.

As described above, the image processing device according to this embodiment generates one file by binding a plurality of image files to each other, and transmits the one file. Upon reception of such a file, the image display device displays thumbnail images for the respective files constituting the file. Each thumbnail image is generated in accordance with an attribute of each file. In this case, the image display device displays a list of received files, and thumbnail images of the respective files contained in any selected files. When a user selects a file from the list, display of thumbnails images is switched. According to this operation, even in the case of transferring a file having a plurality of files, the file can be readily handled. In addition, since display of a file corresponds to display of a thumbnail image, even when a large number of files are transmitted, each file can be readily recognized.

### Fourth Embodiment

Hereinafter, description will be given of a fourth embodiment of the present invention. An image processing device according to this embodiment is different from that according to each of the aforementioned embodiments in the following point. That is, the image processing device according to this embodiment has a function capable of displaying an image on the basis of image data which is retained in the interior of the device and to which access is restricted, without transmitting an image file to another image processing device.

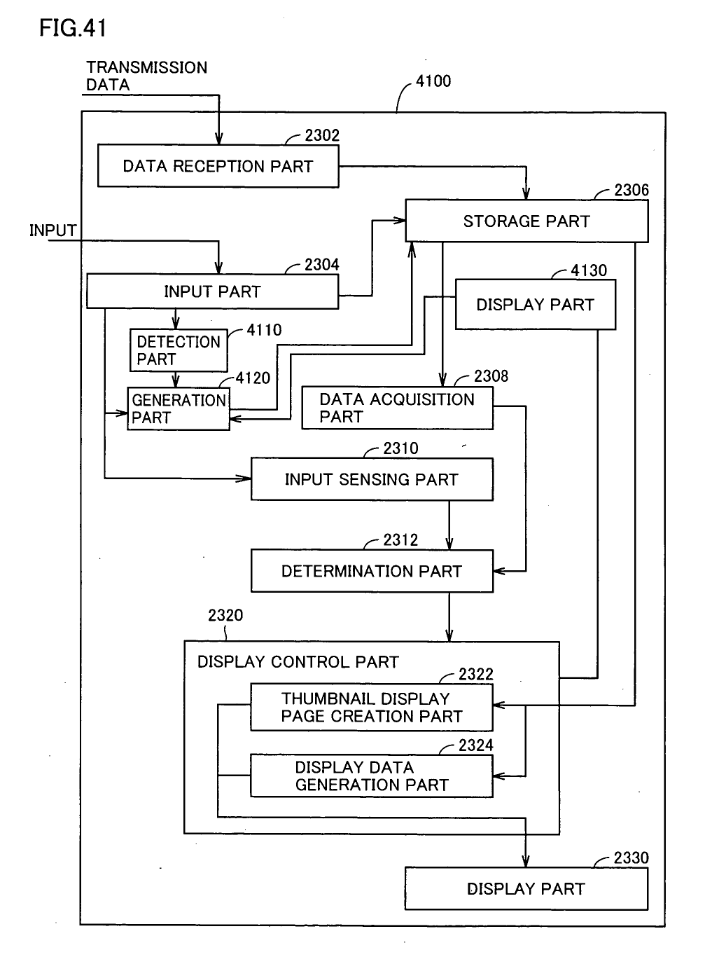

With reference to FIG. 41, description will be given of a configuration of an image processing device 4100 according to this embodiment. FIG. 41 is a block diagram which shows a configuration of functions realized by image processing device 4100.

Image processing device 4100 further includes a detection part 4110, a generation part 4120 and a template storage part 4130 in addition to the configuration of image display device 150 shown in FIG. 23.

Template storage part 4130 stores a template prepared in advance. This template is data for displaying a thumbnail image in accordance with attribute information of a file.

Detection part 4110 detects a file displaying instruction from a signal that input thereof is accepted by input part 2304. Generation part 4120 generates image data for displaying an image of a file, on the basis of the file displaying instruction detected by detection part 4110 and the template stored in template storage part 4130. Generation part 4120 stores the generated image data in storage part 2306.

Display control part 2320 controls image display in display part 2330 on the basis of the image data stored in storage part 2306 or the template stored in template storage part 4130. In the case where an authentication level of a user of image processing device 4100 to which the displaying instruction is inputted undergoes access restriction, display control part 2320 generates image data notifying a fact that a designated file cannot be viewed on the basis of the data stored in template storage part 4130. When the data is sent to display part 2330, display part 2330 displays an image notifying the fact on the basis of the image data.

On the other hand, in the case where the authentication level of the user does not undergo access restriction, display control part 2320 generates image data for displaying a thumbnail image of a file designated on the basis of the data stored in storage part 2306. When display control part 2320 sends the image data to display part 2330, display part 2330 displays the thumbnail image.

Concretely, image processing device 4100 is realized by the hardware configuration shown in FIG. 3 or 22. Hereinafter, specific description will be given of image processing device 4100 with the use of the hardware configuration shown in FIG. 3.

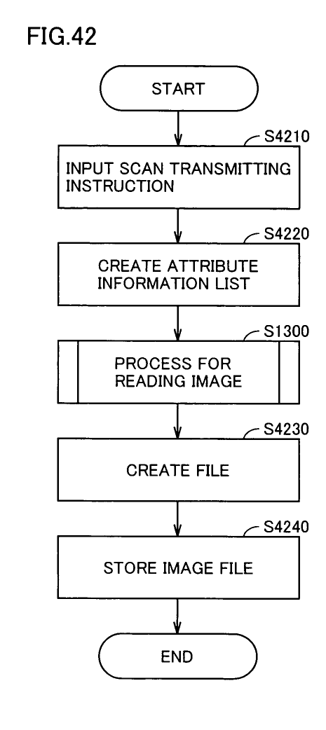

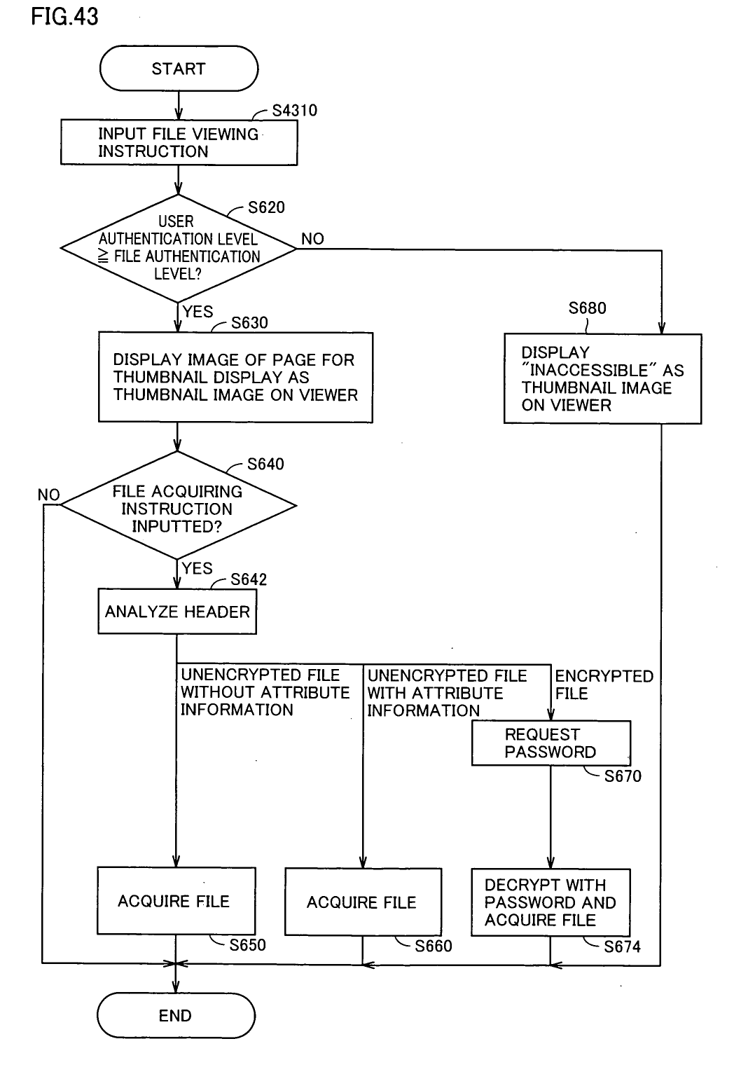

With reference to FIGS. 42 and 43, description will be given of a control structure of image processing device 4100. FIG. 42 is a flowchart which shows a procedure of processes executed by CPU 110 realizing image processing device 4100 for the purpose of generating an image file. It is to be noted that the same processes as the aforementioned processes are denoted by the same step numbers; therefore, description thereof will not be repeated herein.

In step S4210, CPU 110 senses input of a scanning instruction on the basis of input through operation panel 114. This instruction is sensed, for example, in response to depression of “manuscript read button” (not shown) provided in operation panel 114. In step S4220, CPU 110 creates an attribute information list on the basis of the input through operation panel 114.

In step S4230, CPU 110 creates a file on the basis of the read data. More specifically, CPU 110 generates files (e.g., files 102 and 202) on the basis of the image file stored in work RAM 115 and the data stored in user data memory 111 after the data reading.

In step S4240, CPU 110 stores the generated image file in image retention memory 113. Thus, the image file is retained in a nonvolatile manner and, therefore, can be read out in accordance with subsequent input of a displaying instruction.

FIG. 43 is a flowchart which shows a procedure of processes executed by CPU 110 in response to input of an image file displaying instruction. It is to be noted that the same processes as those shown in FIG. 6 are denoted by the same step numbers; therefore, description thereof will not be repeated herein.

In step S4310, CPU 110 senses-input of a file viewing instruction on the basis of input through operation panel 114. The file viewing instruction includes operations by a user of image processing device 100, for example, input of an instruction for displaying all files stored in image processing device 4100 as a list, input of an instruction for selecting a file from the displayed list, and input of an instruction for firmly determining the selection of the file.

Thereafter, comparison between a user authentication level and a file authentication level is made (step S620), and an image is displayed in accordance with the results of comparison (steps S630 and S680).

As described above, image processing device 4100 according to this embodiment restricts display of the read image file in accordance with a file authentication level added as attribute information and an authentication level possessed by a person who views the file. Accordingly, it becomes possible to permit viewing of a file and other operations only to a specific person. According to such a configuration, a user having access authority can readily grasp details of a file which is desired to view. As a result, it is possible to readily manage access of files in single image processing device 4100 with respect to a plurality of users.

It is to be noted that the image processing device according to the present invention is not limited to those shown in the aforementioned embodiments. In another aspect of the present invention, for example, an image processing device may be the one which transmits data for displaying an image to an image display device connected to a network. The image display device may include a display part which displays an image based on the data. The image transmission device may include an input part which accepts input of image data for displaying an image and attribute information of the image. The attribute information may contain data for allowing the image display device to display information. The image transmission device may further include a storage part which stores specification information for specifying the image display device in the network, a generation part which generates an image file for displaying the image and the attribute information, on the basis of the image data and the attribute information, and a transmission part which transmits the image file generated by the generation part to the image display device on the basis of the specification information.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing device comprising:
an input part to accept input of image data and attribute information containing instruction information for instructing an operation for said image data;
an image file generation part to generate an image file capable of displaying an image based on said image data or said attribute information on the basis of said image data and said attribute information that the input thereof is accepted by said input part;
a storage part to store said image file generated by said image file generation part; and
a display part to display said image or said attribute information on the basis of said image file stored in said storage part.

2. The image processing device according to claim 1, wherein
said image file contains:
first image data that input thereof is accepted by said input part; and
said attribute information that the input thereof is accepted by said input part.

3. The image processing device according to claim 2, wherein
said image file further contains second image data for displaying said attribute information that the input thereof is accepted by said input part.

4. The image processing device according to claim 3, wherein
said image file generation part performs an encrypting process to said first image data and does not perform said encrypting process to said second image data.

5. The image processing device according to claim 3, further comprising:
a creation part to create said second image data on the basis of said attribute information that the input thereof is accepted by said input part, wherein
said image file generation part generates said image file containing said second image data created by said creation part.

6. The image processing device according to claim 3, further comprising:
a second image data storage part to store said second image data prepared in advance;
a second image data display part to display said second image data stored in said second image data storage part; and
a selection part to select said second image data displayed on said second image data display part, wherein
said image file generation part generates an image file containing said second image data selected by said selection part.

7. The image processing device according to claim 3, wherein
said image file generation part includes:
a binding part to bind a plurality of pieces of image data that input thereof is accepted by said input part to each other; and
a generation part to generate a plurality of said second image data for the purpose of displaying said attribute information for each of said plurality of pieces of image data.

8. The image processing device according to claim 1, wherein
said input part further accepts input of control data for controlling whether or not said image can be displayed, and
said image file generation part generates said image file on the basis of said control data.

9. The image processing device according to claim 8, wherein
in the case of receiving permission data for permitting display of said image, said image file generation part generates a file for permitting display of said image, as said image file, in accordance with the input of said permission data.

10. The image processing device according to claim 8, wherein
in the case of receiving prohibition data for prohibiting display of said image, said image file generation part generates a file for prohibiting display of said image, as said image file, in accordance with the input of said prohibition data.

11. The image processing device according to claim 8, wherein
said image file generation part generates said image file without addition of data for prohibiting display of said attribute information.

12. An image processing system comprising:
an image display device which displays an image on the basis of data inputted via a network; and
an image processing device which is connected to said image display device through said network, wherein
said image processing device includes:
an input part to accept input of image data for displaying an image and attribute information of said image;
a storage part to store specification information for specifying a position of said image display device in said network;
a generation part to generate an image file capable of displaying said image and said attribute information on the basis of said image data and said attribute information; and
a transmission part to transmit the image file generated by said generation part to said image display device on the basis of said specification information.

13. An image processing method comprising the steps of:
accepting input of image data and attribute information containing instruction information for instructing an operation for said image data;
generating an image file capable of displaying said image or said attribute information on the basis of said image data and said attribute information that the input thereof is accepted;
storing said generated image file; and
displaying said image or said attribute information on the basis of said stored image file.

14. The image processing method according to claim 13, wherein
said image file contains:
first image data that the input thereof is accepted; and
said attribute information that the input thereof is accepted.

15. The image processing method according to claim 14, wherein
said image file further contains second image data for displaying said attribute information that the input thereof is accepted.

16. The image processing method according to claim 15, wherein
said generating step includes the steps of:
performing an encrypting process to said first image data; and
performing no encrypting process to said second image data.

17. The image processing method according to claim 15, further comprising the step of:
creating said second image data on the basis of said attribute information that the input thereof is accepted, wherein
said generating step generates said image file containing said created second image data.

18. The image processing method according to claim 14, further comprising the steps of:
storing said second image data prepared in advance;
displaying said second image data; and
selecting said displayed second image data, wherein
said generating step generates an image file containing said selected second image data.

19. The image processing method according to claim 14, wherein
said generating step includes the steps of:
binding a plurality of pieces of image data that input thereof is accepted to each other; and
generating a plurality of said second image data for the purpose of displaying said attribute information for each of said plurality of pieces of image data.

20. The image processing method according to claim 13, further comprising the step of:
accepting input of control data for controlling whether or not said image can be displayed, wherein
said generating step generates said image file on the basis of said control data.

21. A recording medium in which a program for controlling an image processing device is stored, wherein
said program allows said image processing device to execute the steps of:
accepting input of image data and attribute information containing instruction information for instructing an operation for said image data;
generating an image file capable of displaying said image or said attribute information on the basis of said image data and said attribute information that the input thereof is accepted;
storing said generated image file; and
displaying said image or said attribute information on the basis of said stored image file.
